(19) United States
(12) Patent Application Publication
(10) Pub. No.: US 2014/0064700 A1
(43) Pub. Date: Mar. 6, 2014

(54) SCENE REPRODUCTION APPARATUS, SCENE REPRODUCTION PROGRAM, AND SCENE REPRODUCTION METHOD

(71) Applicant: KABUSHIKI KAISHA TOSHIBA, Tokyo (JP)

(72) Inventors: Yuki Kaneko, Kawasaki-shi (JP); Hideo Kataoka, Tokyo (JP)

(73) Assignee: KABUSHIKI KAISHA TOSHIBA, Tokyo (JP)

(21) Appl. No.: 14/014,031

(22) Filed: Aug. 29, 2013

Related U.S. Application Data
(63) Continuation of application No. PCT/JP2013/062992, filed on Apr. 30, 2013.

(30) Foreign Application Priority Data
Aug. 30, 2012 (JP) 2012-190102

(51) Int. Cl. H04N 9/87

(52) U.S. Cl. CPC H04N 9/87
USPC 386/241

(57) ABSTRACT

According to one embodiment, a reproduction apparatus includes a communicator module, a selector, a detector, and a reproducer. The communicator is configured to receive, from a server, one or more items regarding scene information corresponding to one or more scenes in one or more content items. The selector is configured to select a first item regarding scene information from the one or more items regarding scene information in response to a selection operation. The detector is configured to detect a first scene in a first content item corresponding to the first item regarding scene information. The reproducer is configured to reproduce the first scene.

### CROSS REFERENCE TO RELATED APPLICATIONS

This application is a Continuation Application of PCT Application No. PCT/JP2013/062992, filed Apr. 30, 2013 and based upon and claiming the benefit of priority from Japanese Patent Application No. 2012-190102, filed Aug. 30, 2012, the entire contents of all of which are incorporated herein by reference.

### FIELD

Embodiments described herein relate generally to a scene reproduction apparatus, a scene reproduction program, and a scene reproduction method.

### BACKGROUND

In recent years, digital TVs (DTVs) capable of browsing Internet sites have been popularized. The DTVs can not only receive and reproduce broadcast content but also output information on various sites on the Internet. Furthermore, the DTVs can accept merchandise purchase procedures via various sites.

As described above, the DTVs have not only the broadcast content reproduction function but also the network communication function. These functions are often used separately and use of their combination is in its infancy. Therefore, the technique for combining the functions to improve service has been desired.

In addition, recent DTVs, recorders, or the like can record a considerable number of content items and there have been demands that people want to reproduce an enormous number of recorded content items efficiently.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 schematically shows a system configuration according to an embodiment;

FIG. 2 schematically shows a system configuration according to the embodiment;

FIG. 3 schematically shows a system configuration according to the embodiment;

FIG. 4 is a table that describes the definitions and meanings of terms and abbreviations used in the embodiment;

FIG. 5 shows a software configuration according to the embodiment;

FIG. 6A is a table that describes an example of a Scenefo and a SceneList function;

FIG. 6B is a table that describes an example of the Scenefo and SceneList functions;

FIG. 6C is a table that describes an example of the Scenefo and SceneList functions;

FIG. 7 shows an example of the transition of Scenefo and SceneList screens;

FIG. 8 shows an example of the transition of application start-up screens;

FIG. 9 is a table that describes the definitions and meanings of terms and abbreviations used in the embodiment;

FIG. 10 shows the linkage between various servers according to the embodiment;

FIG. 11 schematically shows a configuration of a metadata server according to the embodiment;

FIG. 12A is a table that describes an example of metadata included in scene information;

FIG. 12B is a table that describes an example of metadata included in scene information;

FIG. 12C is a table that describes an example of metadata included in scene information;

FIG. 12D is a table that describes an example of metadata included in scene information;

FIG. 13 shows the details of a system configuration according to the embodiment;

FIG. 14 shows the way services are offered using scene information;

FIG. 15A illustrates a general outline of the transition of screens;

FIG. 15A1 illustrates a general outline of the transition of screens;

FIG. 15A2 illustrates a general outline of the transition of screens;

FIG. 15B illustrates a general outline of the transition of screens;

FIG. 15C illustrates a general outline of the transition of screens;

FIG. 15D illustrates a general outline of the transition of screens;

FIG. 16 illustrates the details of the transition of screens;

FIG. 17 illustrates the details of the transition of screens;

FIG. 18 illustrates the details of the transition of screens;

FIG. 19 illustrates the details of the transition of screens;

FIG. 20 illustrates the details of the transition of screens;

FIG. 21 shows an example of a screen;

FIG. 22 shows an example of a screen;

FIG. 23 shows an example of a screen;

FIG. 24 shows an example of a screen;

FIG. 25A is a table showing an example of a ScenePlay function list;

FIG. 25B is a table showing an example of a ScenePlay function list;

FIG. 25C is a table showing an example of a ScenePlay function list;

FIG. 26 shows an example of the transition of ScenePlay screens;

FIG. 27 shows an example of a cloud menu screen;

FIG. 28 shows an example of a screen after the transition;

FIG. 29 shows an example of a screen after the transition;

FIG. 30 shows an example of a screen after the transition;

FIG. 31 shows an example of a screen after the transition;

FIG. 32 shows an example of a screen after the transition;

FIG. 33 shows an example of a screen after the transition;

FIG. 34 shows an example of a cloud menu screen;

FIG. 35 is a diagram showing an example of the instantaneous audience rating top 30;

FIG. 36 is a diagram showing an example of the popular scene top 30;

FIG. 37 is a diagram showing an example of Friend's recommended scene information;

FIG. 38 is a diagram showing an example of scene information corresponding to Today's hot words;

FIG. 39 is a diagram showing an example of a user-customized scene reproduction screen; and

FIG. 40 shows a configuration of an information processing apparatus and various functional modules of a DTV according to the embodiment.

### DETAILED DESCRIPTION

Various embodiments will be described hereinafter with reference to the accompanying drawings.

In general, according to one embodiment, a reproduction apparatus includes a reception module, a communicator, a selector, a detector, and a reproducer. The reception module configured to receive an instruction for selection from user in a reproducing of a specific scene of predetermined content. The communicator is configured to receive, from a server, one or more items regarding scene information corresponding to one or more scenes in one or more content items with respect to the specific scene corresponding to the instruction for selection. The selector is configured to select a first item regarding scene information from the one or more items regarding scene information in response to a selection operation. The detector is configured to detect a first scene in a first content item corresponding to the first item regarding scene information. The reproducer is configured to reproduce the first scene.

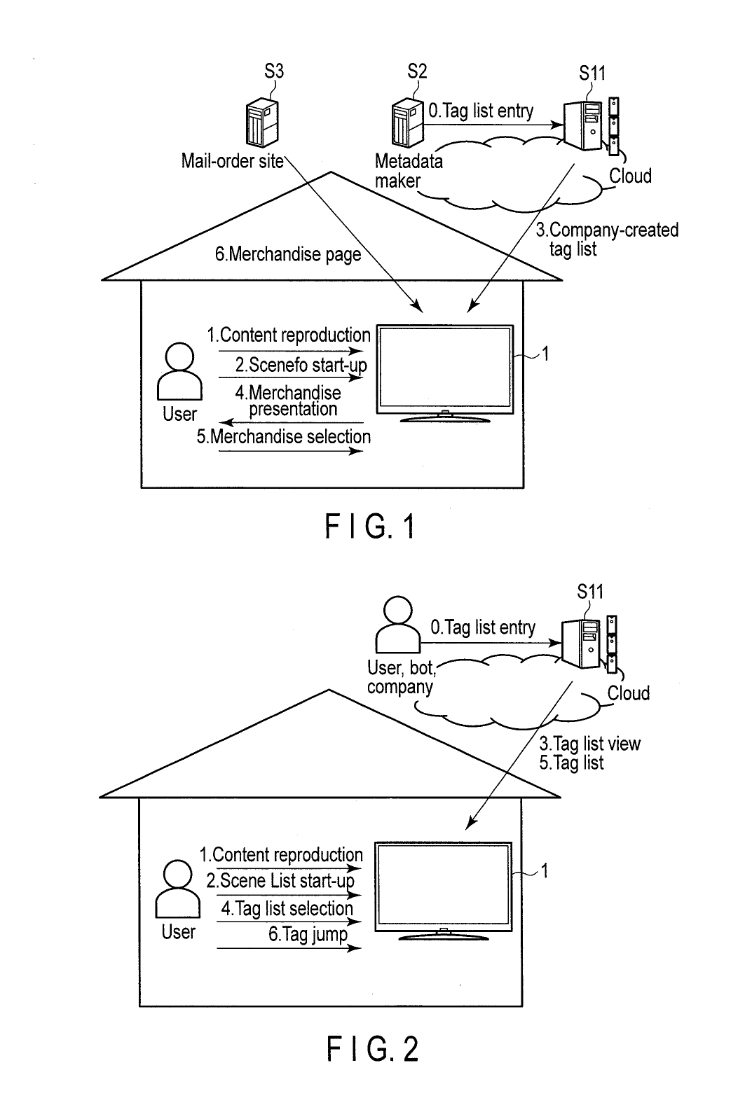

FIGS. 1 to 3 schematically show a system configuration according to an embodiment. A system according to the embodiment comprises various servers (a tag list server S11, a metadata creation server S2, a mail-order site server S3) and a client terminal (for example, DTV) 1. In addition, in the embodiment, a mobile terminal (for example, a tablet computer or a smartphone) 2 can be used. While in the embodiment, a case where a digital TV (DTV) has been applied as a client terminal to a component of the system configuration, the client terminal is not limited to a DTV. Any device may be used, provided that it has a user interface, a communication function, a content processing function, a content output function, a storage function, and the like. For example, a digital recorder is enumerated as one of those devices.

Hereinafter, “Scenefo/SceneList/ScenePlay” applications, time cloud functions provided in a DTV, will be explained. Scenefo means scene information. SceneList means a list obtained by collecting items of scene information. ScenePlay means reproduction using scene information.

A time cloud is a service that connects a tag or scene information created by a metadata maker, a user, a bot, or the like with video content. The time cloud is composed of the following three functions.

<Scenefo>

As shown in FIG. 1, Scenefo is the function of providing scene information on a curious scene being reproduced. A tag list (a registered trademark) used here is, for example, a company-created tag list provided by a metadata maker. In addition, a user-created tag list created by the user may be used.

As shown in FIG. 1, with this system, the following services can be offered by the following processes:

0. Tag list entry

1. Content reproduction

2. Scenefo start-up

3. Transmission and reception of company-created tag list

4. Merchandise presentation (display)

5. Merchandise selection (input operation)

6. Merchandise page offering (display)

<SceneList>

As shown in FIG. 2, SceneList is the function of selectively viewing only the scenes the user wants to view during playback. The user selects a desired scene from a desired one from various tag lists, including a user-created tag list, a tag bot tag list, and a company-created tag list provided by a metadata maker, and views the selected one:

0. Tag list entry

1. Content reproduction

2. Scenefo start-up

3. Transmission and reception of a list of tag lists

4. Tag list selection (input operation)

5. Transmission and reception of a tag list

6. Tag jump

<ScenePlay>

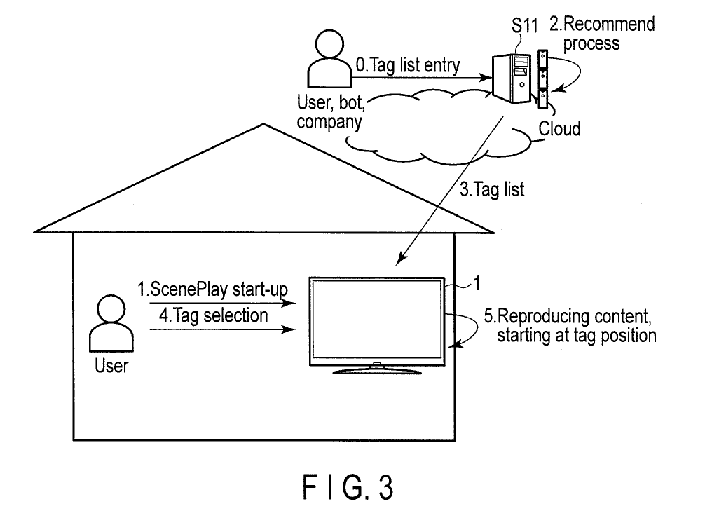

As shown in FIG. 3, ScenePlay is the function of enabling the user to search a large number of items of scene information on reproducible video content for scenes the user is interested in and view them. The user finds curious ones from the recommended scenes, selects the curious ones, and views them. Usable tag lists include various tag lists, including a user-created tag list, a tag bot tag list, and a company-created tag list provided by a metadata maker.

0. Tag list entry

1. ScenePlay start-up

2. Recommend process

3. Transmission and reception of a tag list

4. Tag selection (input operation)

5. Content playback from tag position

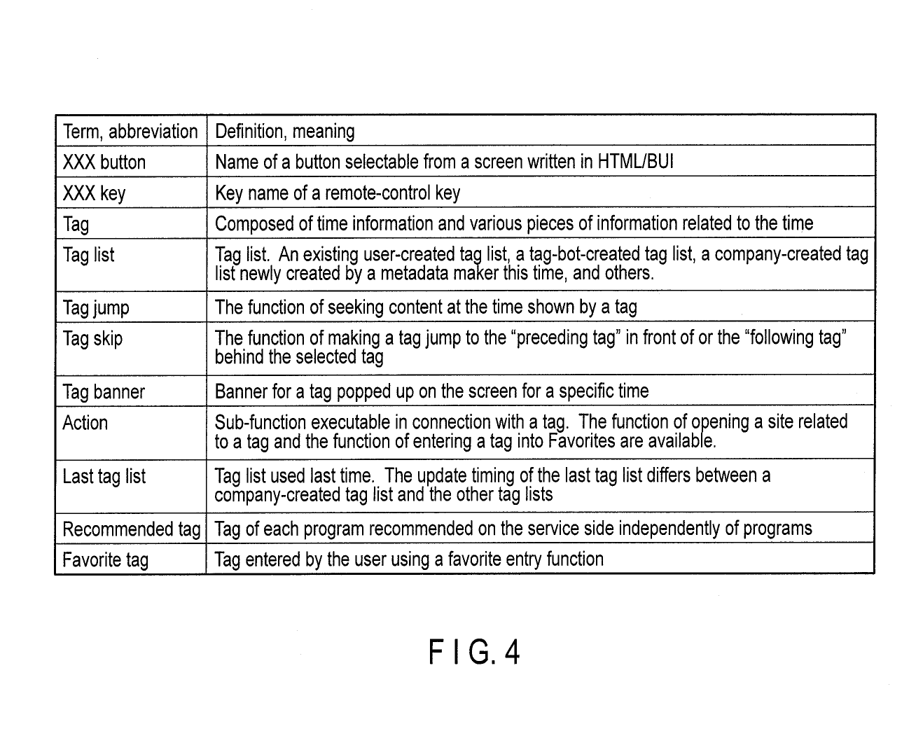

FIG. 4 is a table that describes the definitions and meanings of terms and abbreviations used in the embodiment.

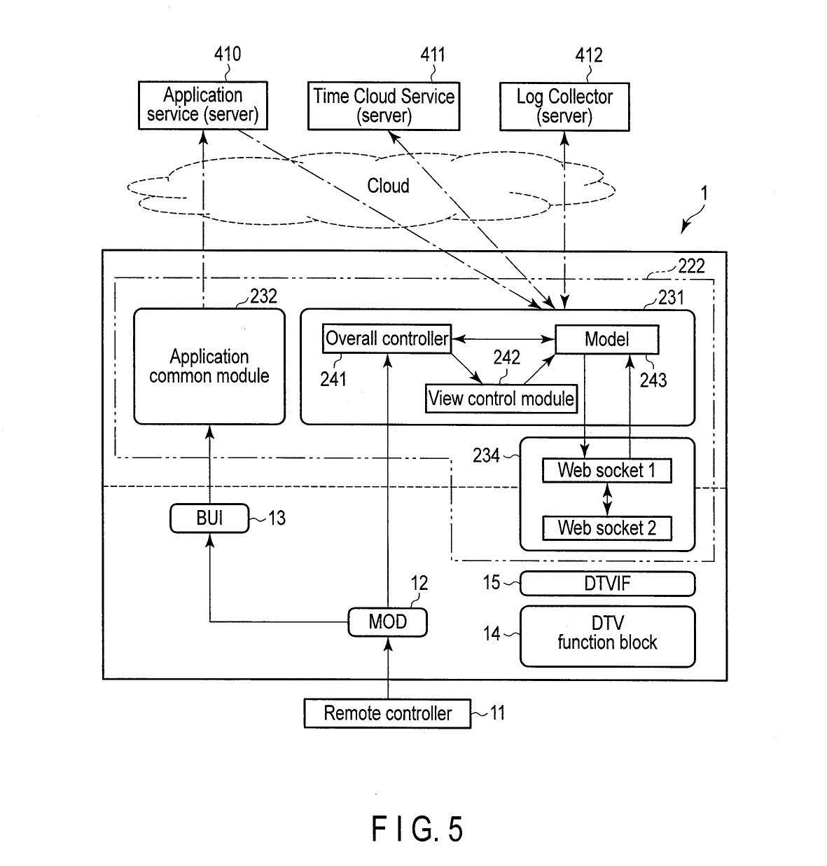

FIG. 5 shows a software configuration according to the embodiment. A time cloud application is broadly composed of a Controller that performs a key event process, a View that performs screen display, and a model that acquires information from DTV middleware (MW) or a server or operates the DTV. For example, various DTV functional modules include not only modules that realize the Scenefo, SceneList, and ScenePlay functions but also modules that realize the reproduction and recording of content, the basic functions of the DTV, and modules that retrieve content items, scenes, or the like.

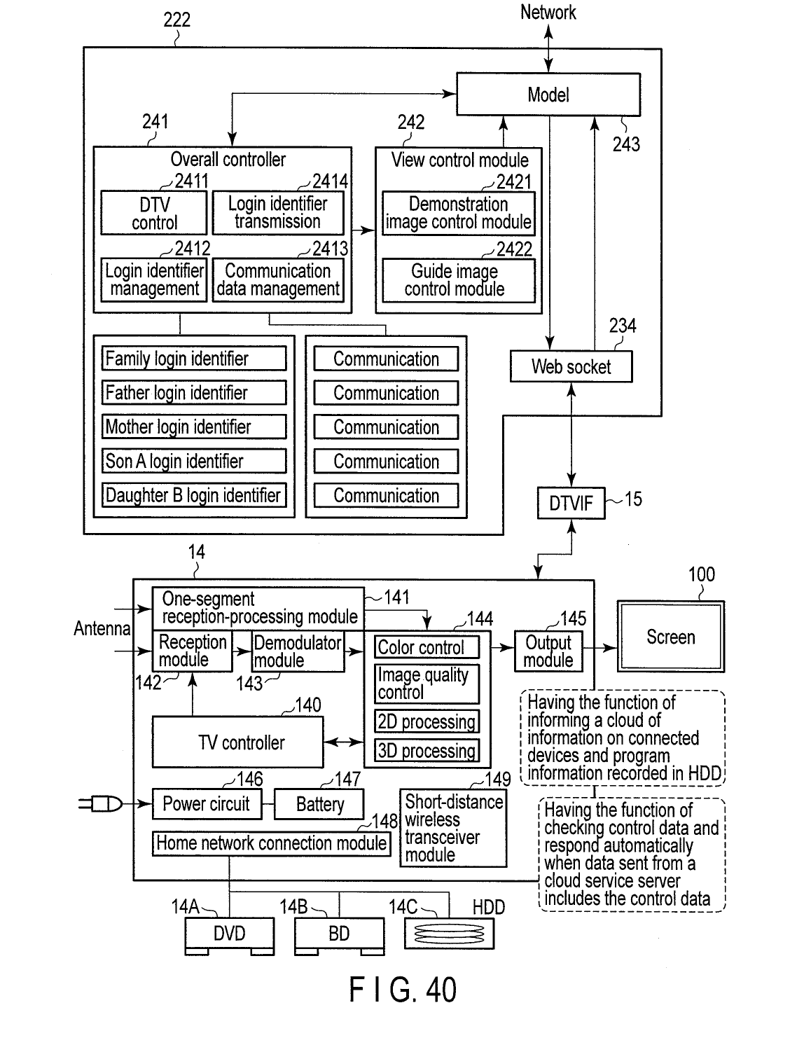

FIG. 5 shows an overall configuration of a DTV 1 to which the information processing apparatus and the information processing method according to the embodiment have been applied. In FIG. 5, the basic functions (including television signal reception, demodulation, control signal processing, 3-D-related signal processing, recording, audio processing, video processing, and a display function) of the DTV 1 are collectively called a DTV function block (or module) 14 (FIG. 40). The DTV function block 14 is connected to an information processing apparatus 222 via a DTV interface 15. The information processing apparatus 222 may be referred to as a browser section.

In the embodiment, the information processing apparatus 222 includes a cloud application module 231, an application common module 232, and a socket module 234. This classification is not restrictive. The cloud application module 231 may be defined as the information processing apparatus 222.

The socket module 234 includes a server web socket viewed from the DTV interface 15 and a client web server viewed from the browser.

The cloud application module 231 includes an overall controller 241, a view control module 242, and a model 243. The overall controller 241 performs various event processes in response to a command or an instruction. The overall controller 241 controls the view control module 242, thereby realizing various drawing processes. The view control module 242 can obtain various images and control signals in the aforementioned screen. The images and control signals based on the operation of the view control module 242 pass through, for example, the model 243 and socket 234 and are displayed as images and control buttons on the display module of the TV apparatus.

The model 243 can access a server, acquire information from a server, transmit information to a server, operate a DTV, and receive data from a DTV. Therefore, the model 243 can receive a message from the DTV and transmit the message to the server. In addition, the model 243 together with the view control module 242 can display the message received from the server on the screen of the display module of the DTV. As for servers, there are an application service server 410, a time cloud service server 411, and a log collector server 412. There are still other servers (not shown).

The user can manipulate the remote controller 11 to control the DTV and information processing apparatus 222. A manipulate signal from the remote controller 11 is distributed at a moderator 12. A key event distributed for use with the cloud application module 231 is input to the overall controller 241. A key event distributed for use with the application common module 323 is input to the application common module 232 via a browser interface 13. The application common module 232 can request a specified application from an application server 410 according to an application request command. The application sent from the application server 410 is taken in by the cloud application module 231 via the model 243. The log collector server 412 can collect logs used in the information processing apparatus 222 and other connection devices.

The time cloud service server 411 can be connected to other various servers and other information processing apparatuses via the network. The time cloud service server 411 can send various service data items to the information processing apparatus. The time cloud service server 411 can relate video content to scene information or a tag list created by a metadata maker or a user. The related data items are arranged on, for example, a table.

Each block and its operation (including the aforementioned operations and operations described below) shown in FIG. 5 may, of course, be realized by a set of instructions constituting software (also referred to as a program). Of course, a processor or a central processing unit (CPU) for realizing data processing with software may be incorporated in each block of FIG. 5. The software, which is stored in a memory (storage medium), can be upgraded. The data (software) in the memory can be read by a computer.

The DTV, which includes a plurality of digital tuners, can receive a plurality of channels at the same time. When signals on a plurality of channels have been demodulated, a plurality of streams are obtained. Each stream includes packets of a television program, a control signal, and the like. The streams of a plurality of programs on a plurality of channels are recorded into, for example, a hard disk drive (HDD) connected via a USB connection cable. The HDD can also record management information for managing program information on recorded programs.

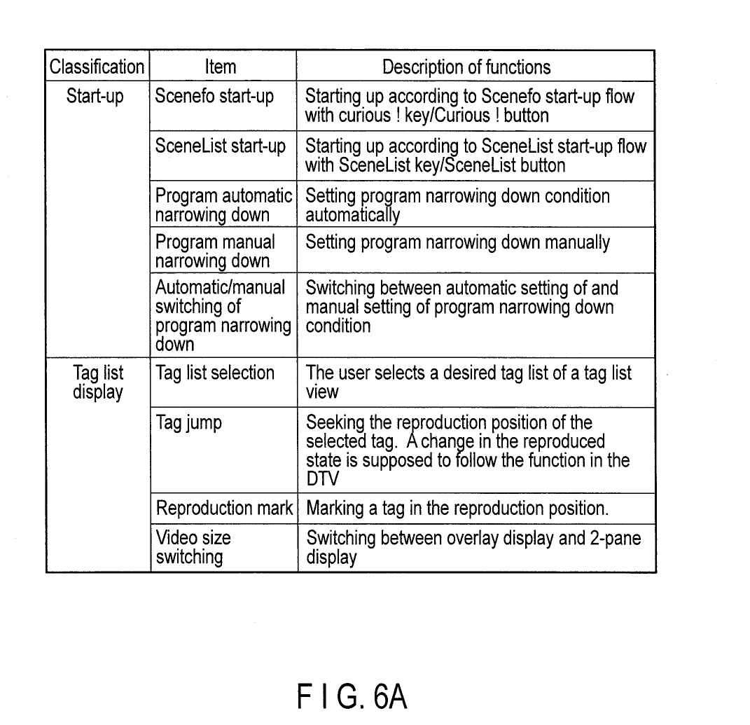

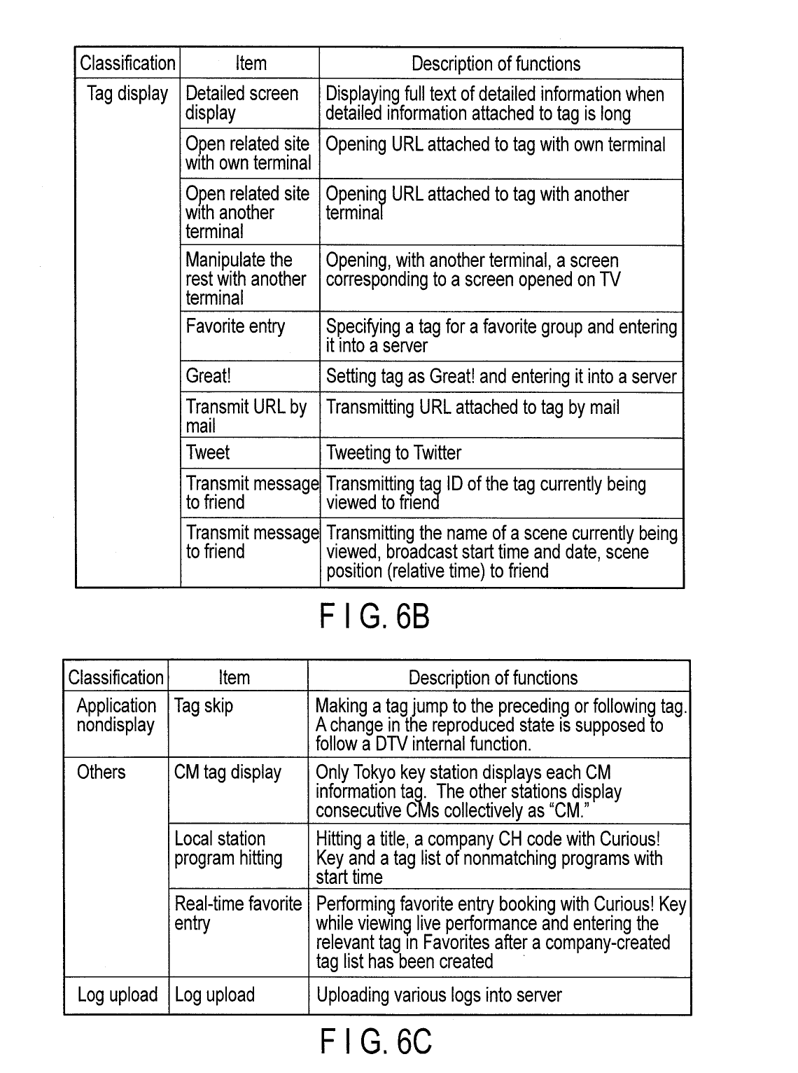

FIGS. 6A, 6B, and 6C are tables that each describe an example of a Scenefo and a SceneList function.

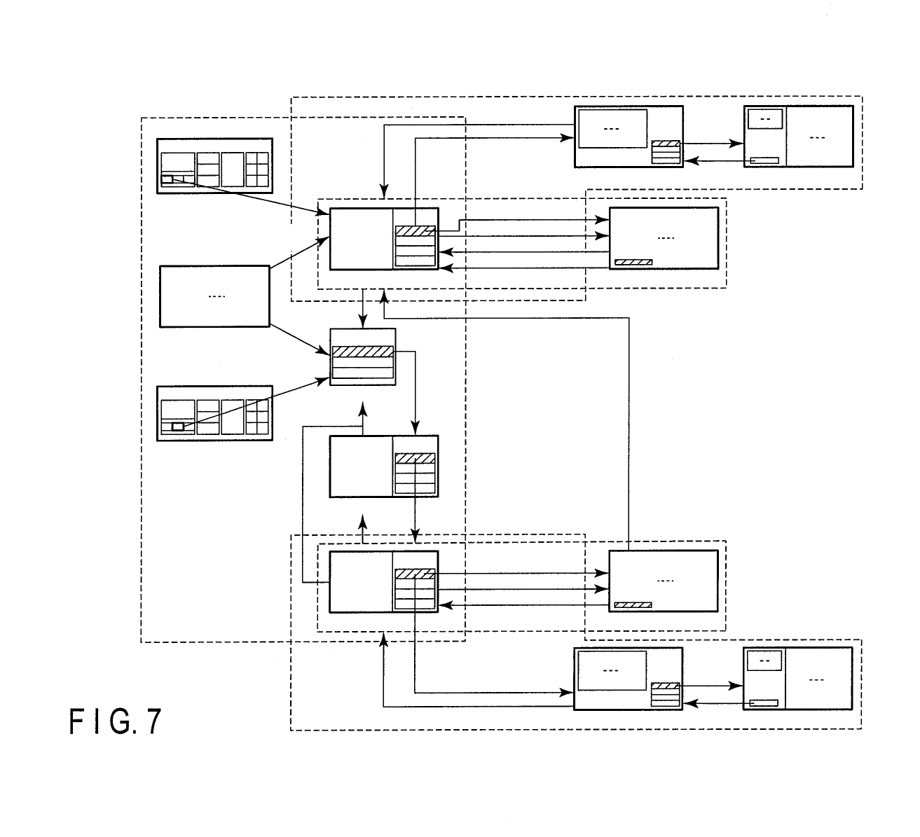

FIG. 7 shows an example of the transition of Scenefo and SceneList screens.

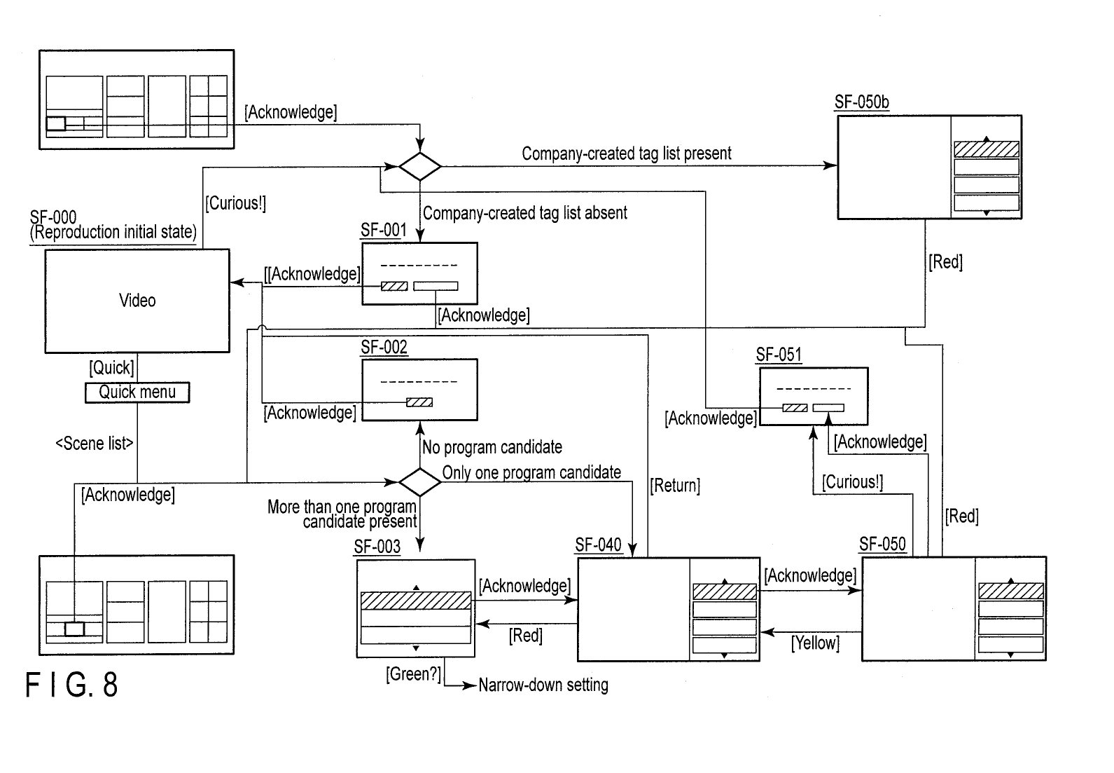

When video content has been reproduced (on a reproduce initial screen) on the DTV, a Scenefo/SceneList application has not been started yet. The user starts the Scenefo/SceneList application. At this time, a browser is also started at the same time the application is started. The transition of application start-up screens is shown in FIG. 8. At the time of screen transition, data related to a tag list is acquired from a metadata server.

Next, a metadata server and others will be explained in detail.

The metadata server is a server that manages program metadata information necessary to realize the Scenefo, SceneList, and ScenePlay functions in the time cloud service. Metadata used in the service is acquired from a metadata creation server at a data provider. The metadata server creates scene information representing detailed information on a scene in a program using the acquired metadata and transmits the created information to a client terminal.

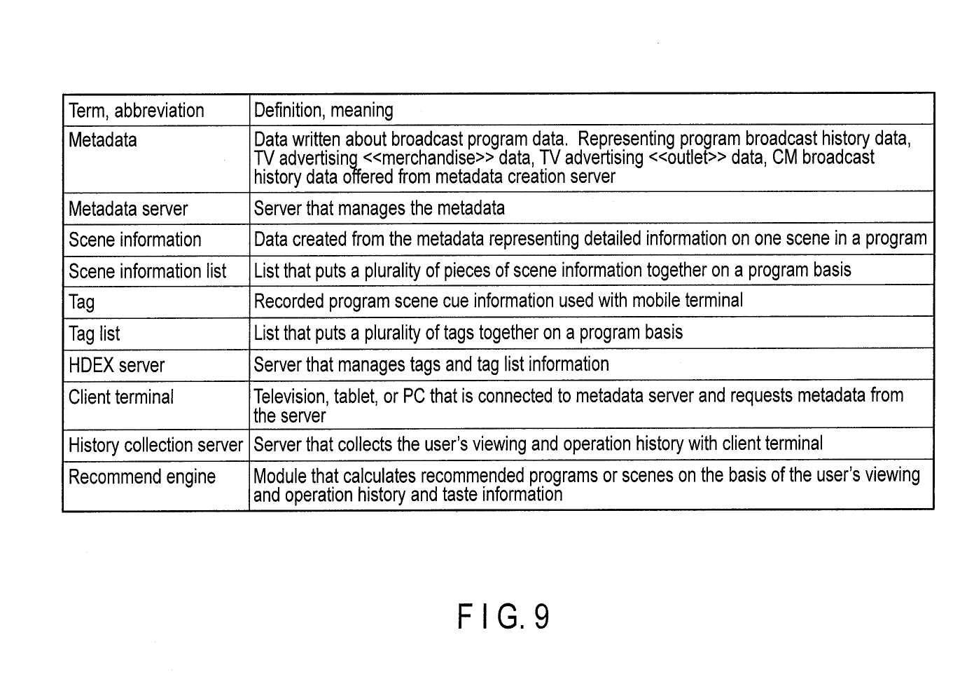

FIG. 9 is a table that describes the definitions and meanings of terms and abbreviations used in the embodiment.

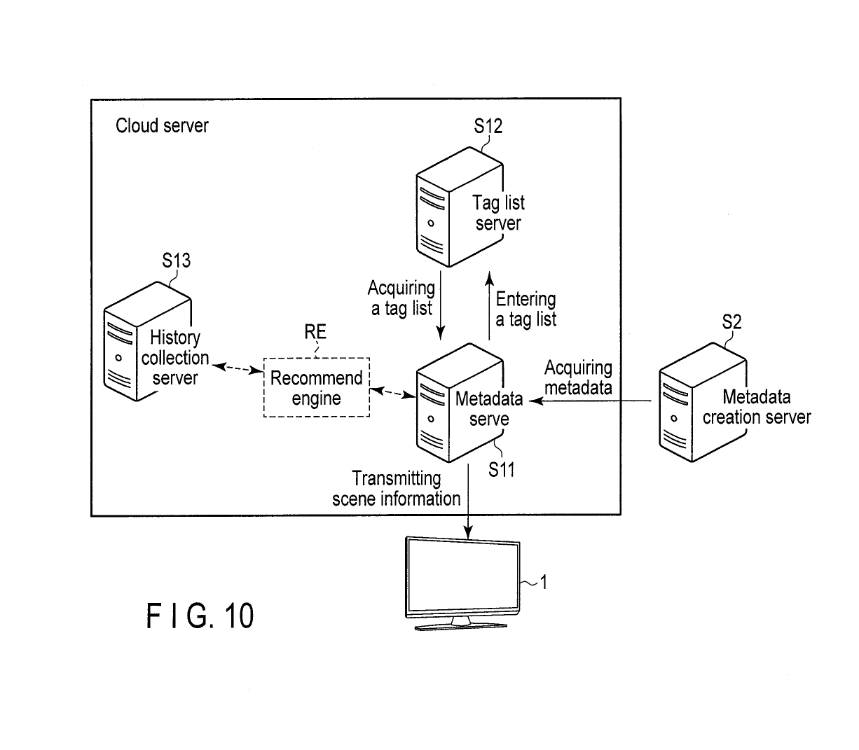

FIG. 10 shows the linkage between various servers according to the embodiment.

A metadata server S11 acquires metadata from a metadata creation server S2 and stores it in a database of the metadata server S11. The metadata server S11 converts a part of the acquired metadata into a format compatible with a tag processing application of a terminal and enters the converted metadata into a tag list server S12 that manages tag list information. The metadata server S11 converts necessary metadata into scene information at the request of a client terminal and transmits the scene information to the client terminal. In addition, the client terminal can acquire user-created tag list information used in the time cloud service from the tag list server S12 by way of the metadata server S11.

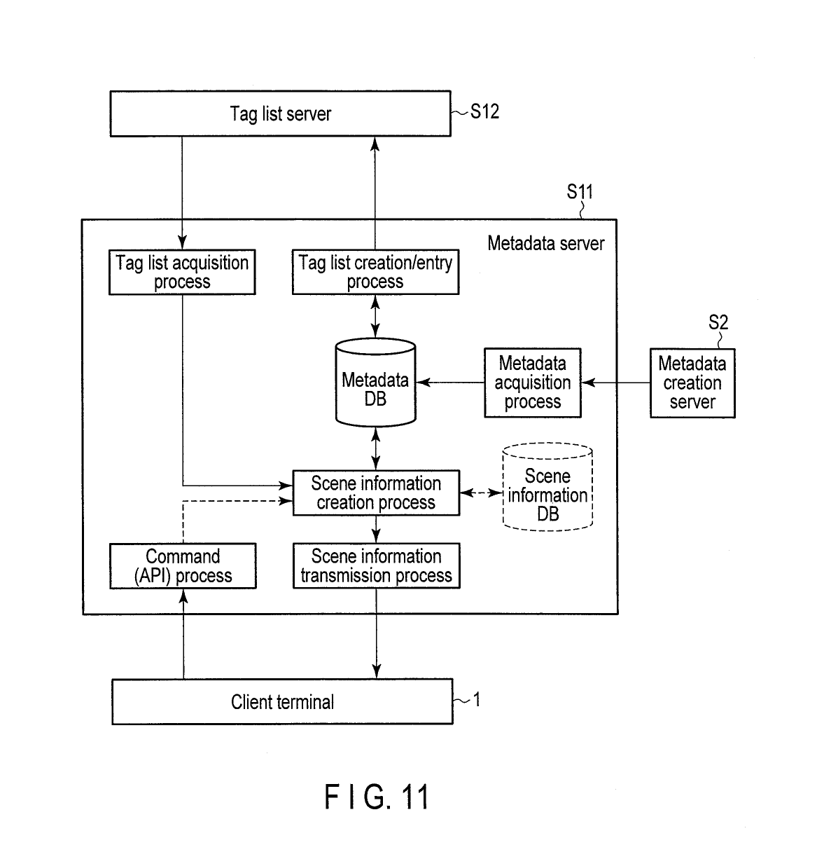

FIG. 11 schematically shows a configuration of a metadata server according to the embodiment.

The functions provided by the metadata server will be described.

(1) Command (Web API) Process

The metadata server S11 acquires various data items and provides them to a client terminal. For example, the metadata server S11 acquires the following data items and offers them to the client terminal.

<Acquiring a Scene Information List>

The metadata server S11 acquires a scene information list for programs that satisfy a specified condition. When there are a plurality of scene information lists for programs that satisfy the specified condition, the metadata server S11 acquires all of them. When there is no scene information list for programs that satisfy the specified condition, the metadata server S11 informs the user of this. A user-created tag list entered in the tag list server S12 may be included in the scene information list to be acquired.

<Acquiring a List of Programs Including a Scene Information List>

The metadata server S11 acquires “a list of programs” including a scene list satisfying the specified condition. A program including in a user-created tag list entered in the tag list server S12 may be included in the list of programs to be acquired.

<Acquiring a List of Scene Information Lists>

The metadata server S11 acquires “a list of scene information lists” entered in a specified program. A list of user-created tag lists entered in the tag list server S12 may be included in the list of lists to be acquired.

<Acquiring a Scene Information List> (ID Specified)

The metadata server S11 acquires “a scene information list” with a specified ID. When a tag list ID has been specified, the metadata server S11 acquires a user-created tag list entered in the tag list server S12.

<Searching for Scene Information>

The metadata server S11 acquires a scene information list including scene information that satisfies a specified search condition. The search condition is such that any keyword the user inputs can be specified.

<Acquiring Recommended Scene Information>

The metadata server S11 acquires “recommended scene” information calculated by a recommend engine RE.

<Acquiring Favorite Scene Information>

The metadata server S11 acquires “favorite scene” information entered by the user managed by a server.

(2) Metadata Acquisition Process

The metadata server S11 acquires metadata provided by the metadata creation server S2. To acquire metadata provided by the metadata creation server S2, Web API provided by the metadata creation server S2 is used.

(3) Tag List Creation/Entry Process

The metadata server S11 enters program broadcast history data in metadata as a tag list in the tag list server S12. The entered metadata, which is compatible with an existing tag list, can be used by an application on a terminal.

(4) Scene Information Creation/Transmission Process

The metadata server S11 creates scene information on the basis of metadata acquired from the metadata creation server S2 and transits the scene information to a client terminal. The processes performed in creating scene information will be described below.

(4.1) Drawing Program Information

A client terminal transmits (a) program name (or identification data, such as program ID), (b) program broadcast time and date, (c) channel number. The metadata server searches a database in the metadata server for an appropriate program on the basis of (a) program name, (b) program broadcast time and date, (c) channel number received from the client terminal. If the appropriate program in which one or more items of scene information have been entered exists, one or more items of scene information on the program have been created and transmitted to a client terminal. If more than one appropriate program exists, all the candidates are transmitted to the client terminal. If there is no appropriate program, the metadata server transmits a message to that effect to the client terminal.

That is, the client terminal transmits content identification data (including the program name, program broadcast time and date, and channel number) to the metadata server and receives a plurality of items of scene information corresponding to a plurality of scenes of the content from the metadata server.

(4.2) Searching for Scene Information

The metadata server searches a database in the metadata server for metadata information that satisfies a search condition received from a client terminal and transmits a scene information list including the appropriate metadata information to the client terminal. Metadata to be searched for includes program broadcast history data, merchandise data (including merchandise name), merchandised handling company data (including company names), store data, and commercial history data.

(4.3) Creating Scene Information

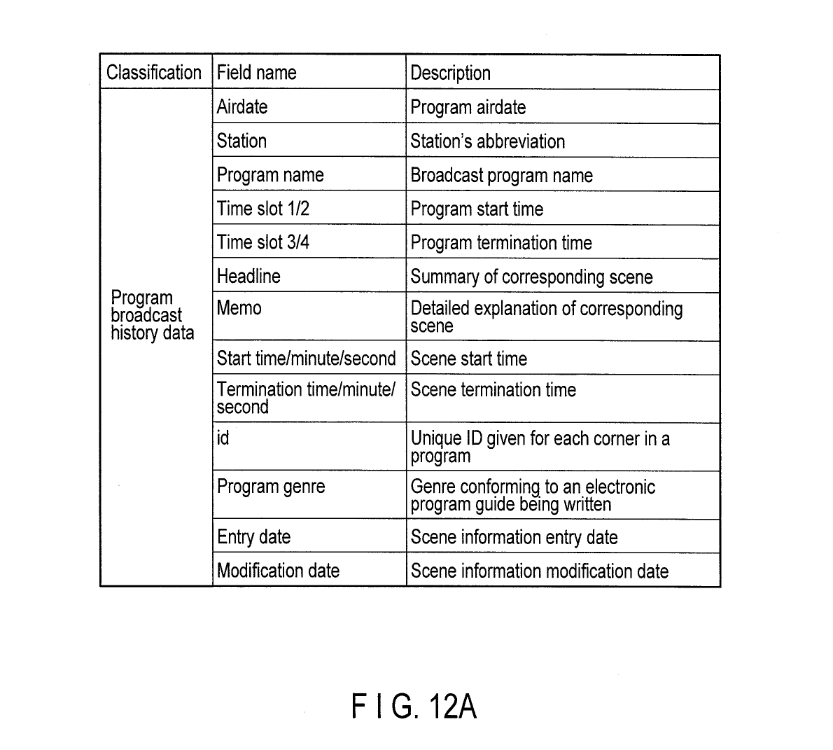

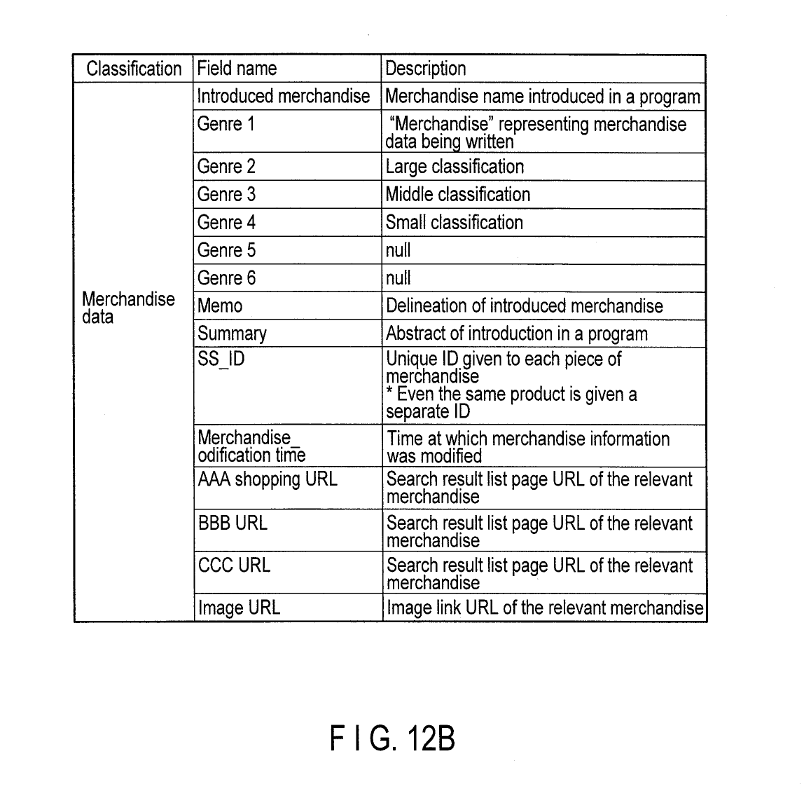

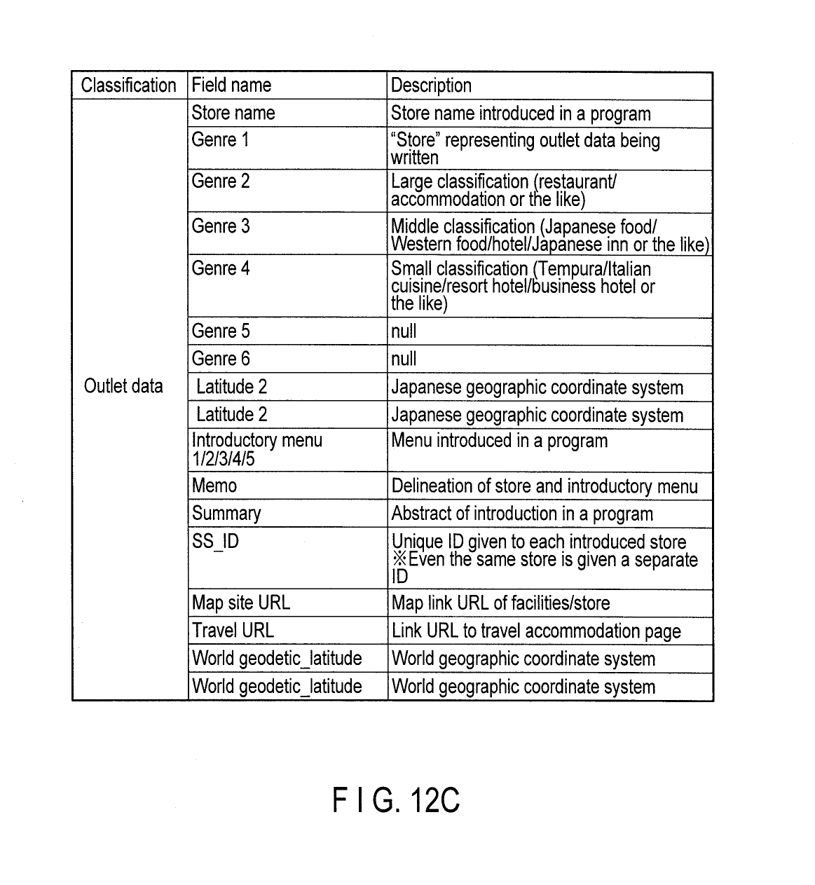

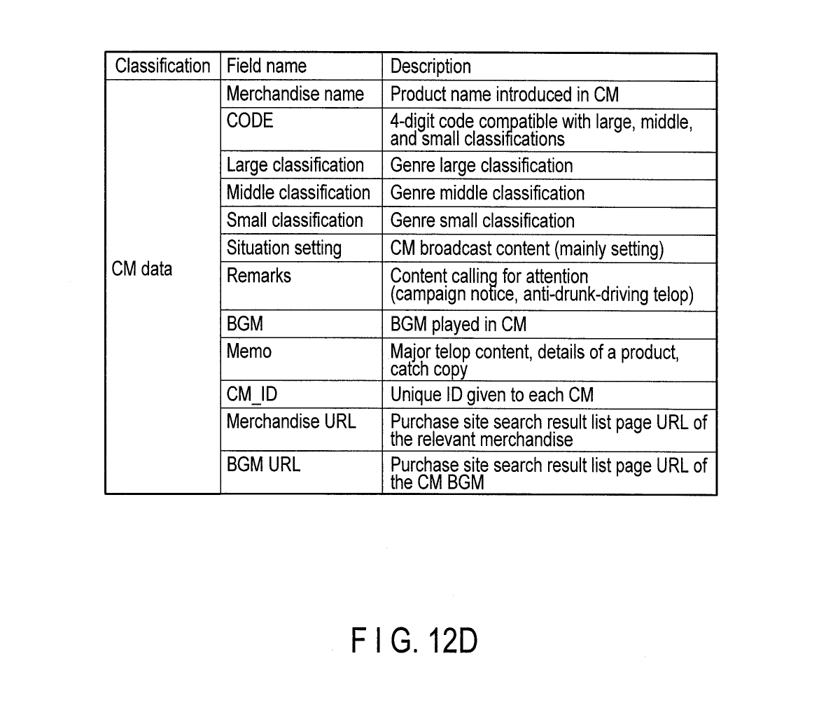

The metadata server correlates the broadcast history data, merchandise data, merchandised handling company data, store data, and commercial history data stored in the database of the metadata server with one another, thereby creating scene information. A list of metadata items included in the created scene information is shown in FIGS. 12A, 12B, 12C, and 12D.

Neither merchandise information nor store information may exist in an item of scene information. A plurality of merchandise data items, merchandise handling company data items, and store data items may be correlated with one another in an item of scene information.

(4.4) Tag List Information and Scene Information Merging Process

Tag list information managed by a tag list server is merged with scene information created in the metadata server at the metadata server at the request of the client terminal and the merged information is transmitted to the client terminal. Since tag termination time has not been written in tag information acquired from the tag list server, the metadata server performs the process of setting the start time of a tag following the attention tag as the termination time of the present tag at the request of the client terminal.

(4.5) Tag List Acquisition Process

The metadata server acquires tag list information entered in the tag list server at the request of the client terminal, performs necessary processes, and transmits the resulting information to the client terminal. To acquire data from the tag list server, API provided by the tag list server is used. Data the metadata server acquires from the tag list server is about tags and tag lists.

(4.6) Transmission Format Conversion Process

Tag list information in XML format acquired from the tag list server is converted into JSON format at the request of a client terminal and the resulting information is transmitted to the client terminal.

FIG. 40 shows a configuration of the information processing apparatus 222 and DTV function block 14 together with the relationship between them. The overall controller 241 includes a DTV control module 2411, a login identifier management module 2412, a communication data management module 2413, and a login identifier transmission module 2414. The DTV control module 2411 may control the DTV function block 14 on the basis of a user operation or control various TV function blocks 14 on the basis of control data from the time cloud service server 411. When a login identifier has been input, the login identifier management module 2412 controls the storage of the login identifier and manages family and individual identifiers as table data. The communication data management module 2413 manages communication data so that the communication data items may correspond to the individual login identifiers. For example, when the user logged in has accessed an external server, the communication data management module 2413 manages its history data. The history data includes an access destination address, transaction data, and the like. The communication data management module 2413 can also classify and store data items sent from the cloud service server 411 and use the data as display data.

The login identifier transmission module 2414 transmits the logged-in login identifier to the cloud service server 411. The cloud service server 411 manages login identifiers from many users and uses them when providing guide images.

The view control module 242 includes a demonstration image control module 2421 and a guide image control module 2422. This enables a demonstration image and a guide image to be provided for the DTV side.

The DTV function block 14 includes a one-segment reception-processing module 141 that receives a signal from an antenna, a reception module 142 that receives satellite broadcasting and terrestrial digital broadcasting, and a demodulator module 143. The reception module 142 and demodulator module 143, which include a plurality of tuners, can receive broadcast programs on a plurality of channels simultaneously and demodulate them. A plurality of demodulated program signals can be converted into a DVD format at a DVD device 14A and recorded onto a digital versatile disc. Alternatively, the demodulated program signals can be converted into a BD format at a BD device 14B and recorded onto a Blu-ray disc. Moreover, in any stream, the demodulated program signals can be recorded onto a hard disk with a hard disk drive 14C. The DVD device 14A, BD device 14B, and hard disk drive 14C are connected to the DTV function block 14 via a home network connection module 148. The hard disk drive 14C may be of a type to be connected via a USB cable. The hard disk drive 14C may be based on a method capable of recording all the programs on a plurality of channels (e.g., set six channels) simultaneously for, for example, about one to three weeks. This type of function may be referred to as a time shift function. In addition, the DTV function block 14 may be configured to include more hard disk drives.

The network connection device and recorded program information can be grasped by a TV controller 140 and transmitted to the cloud service server 411 via the information processing apparatus. In this case, the time cloud service server 411 can grasp the user's home network connection device and recorded program information. Therefore, when each scene is reproduced on the basis of scene list information, the cloud service server 411 can specify even a home connection device in which the various scenes have been recorded.

A program signal demodulated in the DTV function block 14 or a program signal reproduced from a recording medium, such as a DVD, a BD, or an HD (hard disk), is subjected to various adjustments (including brightness adjustment and color adjustment) at a signal processing module 144 and is output to the screen 100 of the display module via an output module 145.

The DTV function block 14 includes a power circuit 146. The power circuit 146 can switch between a use situation of commercial power and a use situation of a battery 147 as needed. The switching between the use situations includes a case where the user performs the switching forcibly by operating the remote controller and a case where the switching is performed automatically on the basis of external information.

The cloud service server 411 can transmit a control signal to bring the TV apparatus into a 3D processing state automatically. Furthermore, the cloud service server 411 can transmit an audio control signal and/or an audio signal corresponding to a scene to the TV apparatus. Moreover, according to a scene, the cloud service server 411 can include image adjustment data in extended linkage data and transmit the resulting data.

The DTV function block 14 includes a short-distance wireless transceiver module 149. The DTV function block 14 can transmit and receive data to and from a mobile terminal via the short-distance wireless transceiver module 149. The mobile terminal can request an operation image from the DTV function block 14. When the DTV function block 14 has been requested to give an operation image, it can transmit a guide image to the mobile terminal. The user can control the information processing apparatus making use of the guide image on the mobile terminal.

The DTV function block 14 can check control data sent from the cloud service server 411 and reflect the data in an operation state automatically.

Therefore, with the system, the information processing apparatus basically transmits data (control signal corresponding to a scene information key, a scene list key, and a scene play key) acting as a trigger to a server via the network connection module in response to a first operation signal from the user. Next, the information processing apparatus acquires extended linkage data sent back on the basis of the trigger data, classifies a first control signal (instruction) for automatic control included in the extended linkage data and a second control signal (instruction) corresponding to the second operation signal from the user, and stores them. They are stored in the overall controller or model. Then, the information processing apparatus can perform an autonomic operation on the basis of the first control signal (instruction) and/or a heteronomous operation on the basis of the second control signal (instruction). The autonomic operation means operating in an autonomic manner. For example, this means obtaining a display image in the area 106 or controlling the DTV function block 14. The heteronomous operation means waiting for a user operation and responding to a second operation signal when the second operation signal from the user is input. This operation includes the operation of responding to merchandise selection, the operation of responding to tag list selection, and the operation of responding to scene list selection. The extended linkage data further includes display data to be displayed. The display data includes various messages and albums. When having received a power-saving instruction from the time cloud service server 411, the DTV function block 14 can perform a power-saving operation. The power-saving operation includes, for example, the change of a full-segment reception state to a one-segment reception state, the reduction of the display area of the display module, and the change of commercial power use to battery use.

In addition, the DTV function block 14 can control the brightness of an area of a moving image in the area 101 so that the brightness may be higher than that of another area. That is, the DTV function block 14 can make the brightness of a guide image in the area 102-104 lower than that of a moving image in the area 101, thereby making the moving image easily viewable. To perform a specific operation, the DTV function block 14 can control the brightness of a guide image pointed to by the cursor so that the guide image may get brighter.

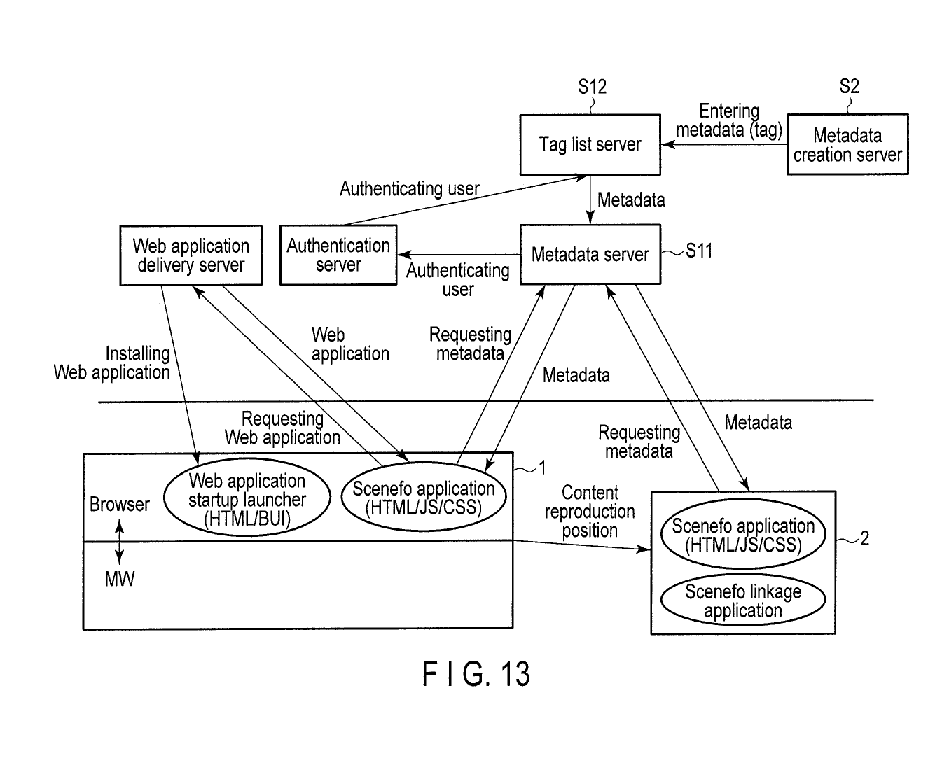

FIG. 13 shows the details of a system configuration according to the embodiment. As explained above, the system is composed of various servers and a client terminal (for example, DTV) 1. In addition, the system enables a mobile terminal (i.e., a tablet computer or a smartphone) 2 to be used.

The DTV senses that each of various buttons and keys is pressed and executes an operation according the pressed button or key. For example, when having sensed that a curiosity key has been pressed while a program is “being reproduced,” the DTV can access information (Scenefo) on “a scene” at the time, open various applications, and offer services related to the “scene.” That is, the curiosity button is a button for giving an instruction to access information on “a scene” at the time while the program is “being reproduced.” For example, a Scenefo application starts, offering services related to the “scene.” That is, when having pressed the curiosity key, the user can get a service corresponding to the “scene” at the time in cooperation between the DTV and the Scenefo application.

For example, when the DTV has reproduced a plurality of scenes in a program (content item) sequentially and the user has pressed the curiosity button while the program is “being reproduced,” the DTV detects the press of the button (scene information request), changes screens, and outputs information (scene information) related to the scene. Each time the scene changes, the DTV changes items of scene information to be output in sequence.

For example, when reproducing a recorded program, the DTV outputs a first item of scene information corresponding to a first scene being reproduced among a plurality of scenes in the program, outputs a second item of scene information corresponding to a second scene before the first scene together with the first item of scene information, and outputs a third item of scene information corresponding to a third scene after the first scene together with the first item of scene information. The DTV outputs the first, second, and third items of scene information together with a playback video of the program and outputs the first item of scene information and the second and third items of scene information in different display formats. For example, the DTV outputs the first item of scene information in a first display color and the second and third items of scene information in a second display color.

Furthermore, scene information will be explained in detail.

(1) When having detected the selection of the output (displayed) scene information, the DTV outputs a link (service information) related to a scene on which scene information is based. The user can buy merchandise related to the scene or reserve a store that offers services related to the scene via a link (for example, URL of a merchandise purchase site or URL of a reservation site of a specific pre-address header) output to the DTV. In addition, the user can transfer the link related to the scene to a car navigation or open a map related to the scene.

(2) When having detected the selection of the output (displayed) scene information, the DTV opens an application on a mobile terminal related to a scene on which scene information is based.

(3) When having detected the selection of the output (displayed) scene information, the DTV enters, into Favorites, information on a scene on which scene information is based.

(4) When having detected the selection of the output (displayed) scene information, the DTV outputs a mail transmission screen for transmitting, by mail, information on a scene on which scene information is based and transmits mail in response to a specific selection or an input operation.

(5) When having detected the selection of the output (displayed) scene information, the DTV transmits, to a friend, information on a scene on which scene information is based, in the form of a message.

The “Great!” button indicating a user evaluation of a program can be pressed at different times. That is, when having detected the press of “Great!” button (scene information request) while a program is “being reproduced,” the DTV can access information on “a scene” (scene information) at the time and make a database of information on “a scene.”

Information indicating the press of the “Great!” button can be caused to correspond to a scene tag, a list, a program, or a specific scene.

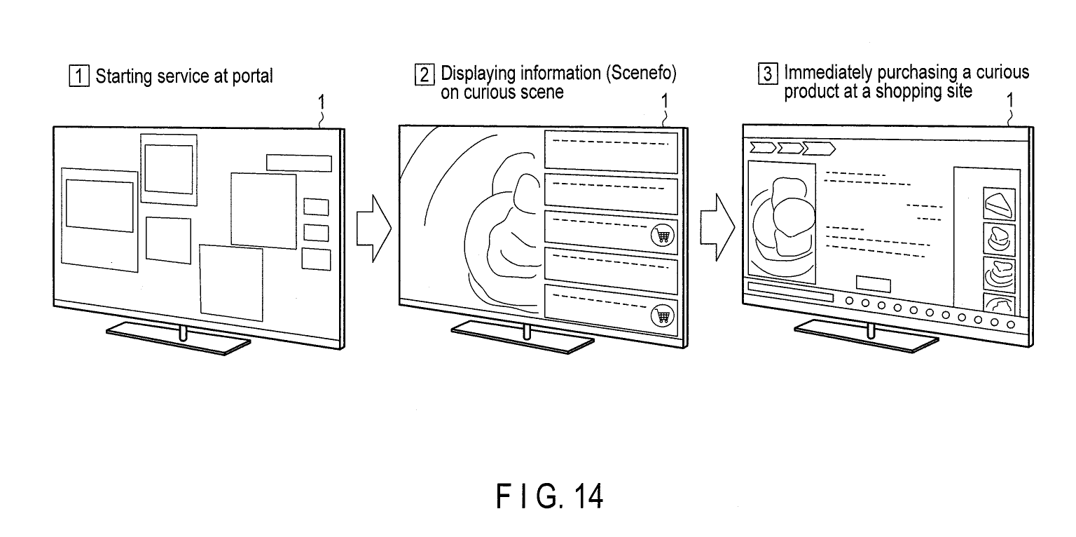

As shown in FIG. 14, the DTV can start service at a portal, display information on a curious scene, and enable the user to buy a curious item of merchandise at a shopping site immediately.

As described above, with the system of the embodiment, pertinent information suited for each of small scenes can be presented timely.

Hereinafter, explanation will be given in concrete terms.

<Operational Specifications>

When the DTV has detected that the [Scenefo] key has been pressed while content of a PVR or a time-shift machine is being reproduced, the DTV displays a list of Scenefo, focusing on the nearest neighboring Scenefo in front of the present reproduction position. The list display may be realized by using another input replacing the [Scenefo] key as a trigger. The time-shift machine is a device that records (or records all the) broadcast content items on a plurality of channels (for example, six channels) for a specific period of time before present (for example, the past 15 days). When the time-shift machine has recorded all the broadcast content items, the user can view the programs broadcast in the past (for example, for the past 15 days) at any time.

For example, in a Scenefo list, a part (about two lines) of Scenefo is displayed in list form.

When there is no Scenefo, the dialogue “Scenefo is not found. Do you want SceneList displayed?” is displayed. If Yes, control proceeds to a SceneList selection screen.

When having detected that [Up] or [Down] key has been pressed while the Scenefo list is being displayed, the DTV moves the cursor to Scenefo.

When having detected that the [Acknowledge] key has been pressed with the cursor hitting against any Scenefo, the DTV reproduces a scene corresponding to the Scenefo hit by the cursor (reproduce jump).

When having detected that the [Return] or [End] key has been pressed while the Scenefo list is being displayed, the DTV closes the Scenefo list.

When having detected that [Right] key has been pressed with the cursor hitting against any Scenefo while the Scenefo list is being displayed, the DTV displays detailed information on Scenefo. Detailed information on Scenefo includes all of Scenefo. The detailed information on Scenefo includes action buttons corresponding to the contents of Scenefo.

For example, the detailed information includes action buttons corresponding to the following functions:

“Enter this scene into Favorites”

“Great!”/“Cancel Great!”/“Great! with a count”

“Open a shopping site on TV”

“Open a shopping site with application”

“Transmit this Scenefo by e-mail”

When having detected that the “Enter this scene into Favorites” key has been pressed, the DTV enters a corresponding scene in Favorites (this can be used in a case where the user wants to do bulk buying later or view this scene again later).

The service server can manage a favorite Scenefo for shared usage with TV/applications or the like.

When the “Great!” button has been pressed, the DTV causes a log representing Great! to correspond to Scenefo and uploads the resulting log to a server. As a result, the count of Great! caused to correspond to Scenefo increases.

When having detected that the “Open a shopping site on TV” button has been pressed, the DTV opens a shopping site with the browser.

When having detected that the “Open a shopping site on application” button has been pressed, the DTV gives the URL of the shopping site to the application. The application opens the shopping site on the basis of the URL.

Even if the DTV has displayed a shopping site, a serious burden of completing the shopping settlement procedure with a remote control or the like of the DTV is imposed on the user. Therefore, as described above, the DTV transmits the URL of the shopping site to the application of the mobile terminal 2 and informs the user that the shopping settlement procedure or the like will be continued on the application of the mobile terminal 2. The user can complete the shopping settlement procedure or the like with the mobile terminal 2 at hand, using, for example, a touch input function.

When displaying a shopping site, the DTV accepts the selection of one of a first mode in which a shopping site is displayed on the DTV body and a second mode in which a shopping site is displayed on the mobile terminal 2. When the user has selected the second mode, the DTV transmits the URL of the shopping site to the application of the mobile terminal 2 without displaying the shopping site. For example, the DTV transfers the URL of the shopping site to the application of the mobile terminal 2 by way of a server. On the basis of the URL of the shopping site, the mobile terminal 2 displays the shopping site.

While the shopping site has been displayed on the mobile terminal 2 in place of the DTV, all the displays or the like on the DTV may be realized on the mobile terminal 2. That is, the DTV can transmit not only the URL of the shopping site but also the URLs of all sites to the mobile terminal 2, enabling the mobile terminal 2 to display all the sites.

When having detected that the “Transmit this Scenefo by mail” button has been pressed, the DTV displays a destination mail address selection screen. The destination mail address selection screen can present mail addresses set in mail booking or the like as candidates and accept the selection of a mail address. In addition, the destination mail address selection screen can accept the input of a mail address. When the user has selected a mail address and pressed the “Transmit” button, the DTV detects that a mail address has been selected and the [Transmit] button has been pressed and transmits a mail.

When having detected that a switching button has been pressed while the Scenefo list is being displayed or the details of Scenefo are being displayed, the DTV can switch between “Full image+overlay Scenefo” representation and “Image and Scenefo division” representation.

When having detected that the [Left] or [Right] key has been pressed while content is being reproduced, the DTV can make a reproduce jump [in front of] or [behind] Scenefo or SceneList.

The DTV operates on the basis of what has been used last (a specific list of Scenefo or SceneList). In default setting, the DTV operates on the basis of Scenefo. When there is no Scenefo and SceneList has never been used while the content is being reproduced, the DTV does nothing.

When having detected that [SceneList use] button has been pressed while the Scenefo list is being displayed, the DTV can move to a SceneList selection screen.

For example, the DTV enables Scenefo to be used as one of the tag lists from the existing “Tag list use.”

In addition, the DTV can display some tag lists, such as only commercial or only merchandise information, from one Scenefo.

When having detected that the [Scenefo] button has been pressed, the DTV can display detailed information on the nearest neighboring Scenefo in front of the present reproduction position.

The DTV always displays the nearest neighboring Scenefo in front of the present reproduction position.

When having detected that the “Open a shopping site with application” button has been pressed, the DTV receives the URL of the shopping site and opens the shopping site with the browser in the application.

When having detected that the “Favorite Scenefo” button has been pressed, the DTV displays a favorite list and opens the shopping site in response to the act of “Open a shopping site” or the like.

<Related Upload Requirements>

DTV:

When having detected that the [Scenefo] key has been pressed in a normal mode, the DTV can upload (Scenefo mode start) reproduction position at which the Scenefo list has been displayed and Scenefo.

The DTV uploads Scenefo used to make a scene jump from the Scenefo list in response to the detection of the [Acknowledge] key being pressed.

The DTV uploads Scenefo used to display the details of Scenefo from the Scenefo list in response to the detection of the [Right] key being pressed.

The DTV uploads the URLs or the like of purchase sites, merchandise sites, outlet sites, or map sites obtained from the details of Scenefo.

The DTV uploads Scenefo corresponding to the details of Scenefo when having transferred the details of Scenefo to the application.

The DTV uploads Scenefo corresponding to the details of Scenefo when having transferred the details of Scenefo by mail.

The DTV uploads Scenefo for which “Great!” has been specified.

The DTV uploads Scenefo entered into Favorites.

Terminal:

When having displayed Scenefo as a result of the [Scenefo] key being pressed, a terminal can upload the reproduction position of Scenefo and Scenefo.

The terminal uploads the URLs or the like of purchase sites, merchandise sites, outlet sites, or map sites obtained from the details of Scenefo.

The terminal uploads Scenefo corresponding to the details of Scenefo when having transferred the details of Scenefo by mail.

The terminal uploads Scenefo for which “Great!” has been specified.

The terminal uploads Scenefo entered into Favorites.

The terminal uploads a tag list use log treating Scenefo as one of the tag lists.

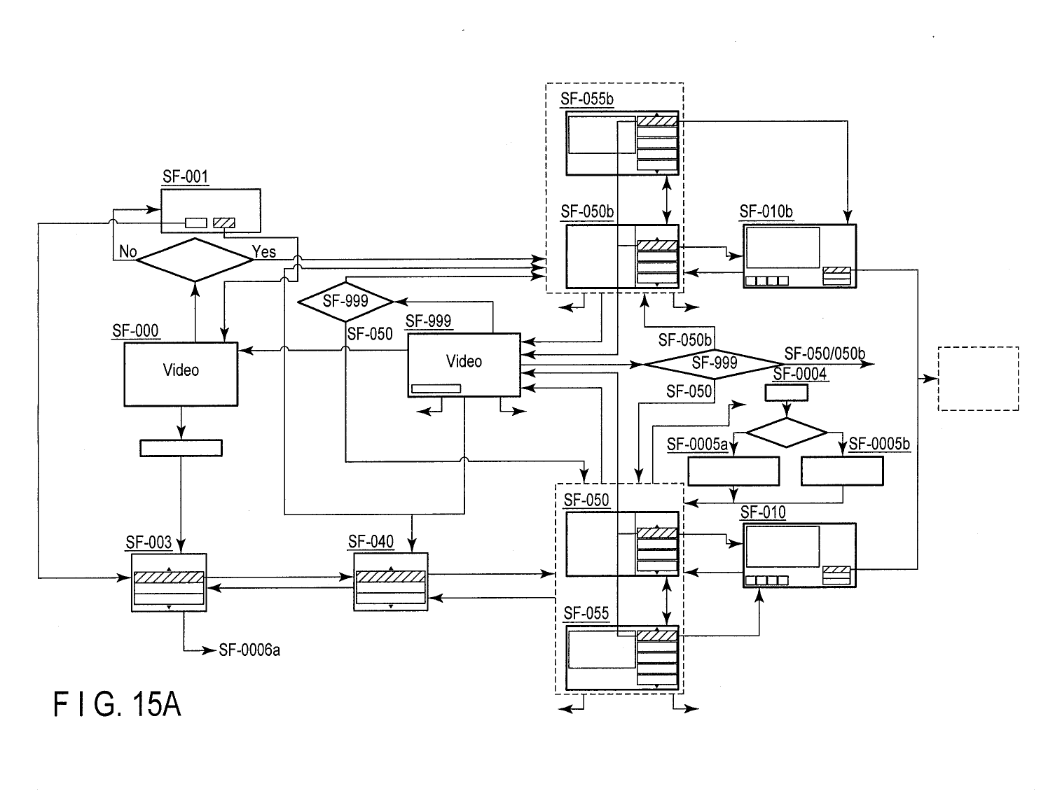

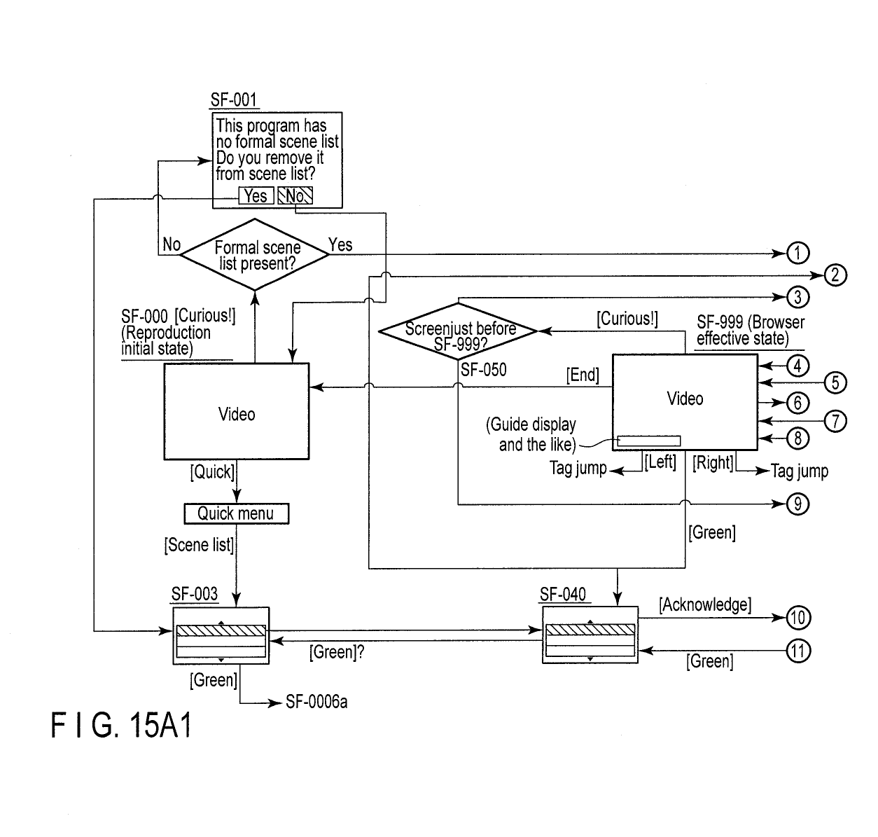

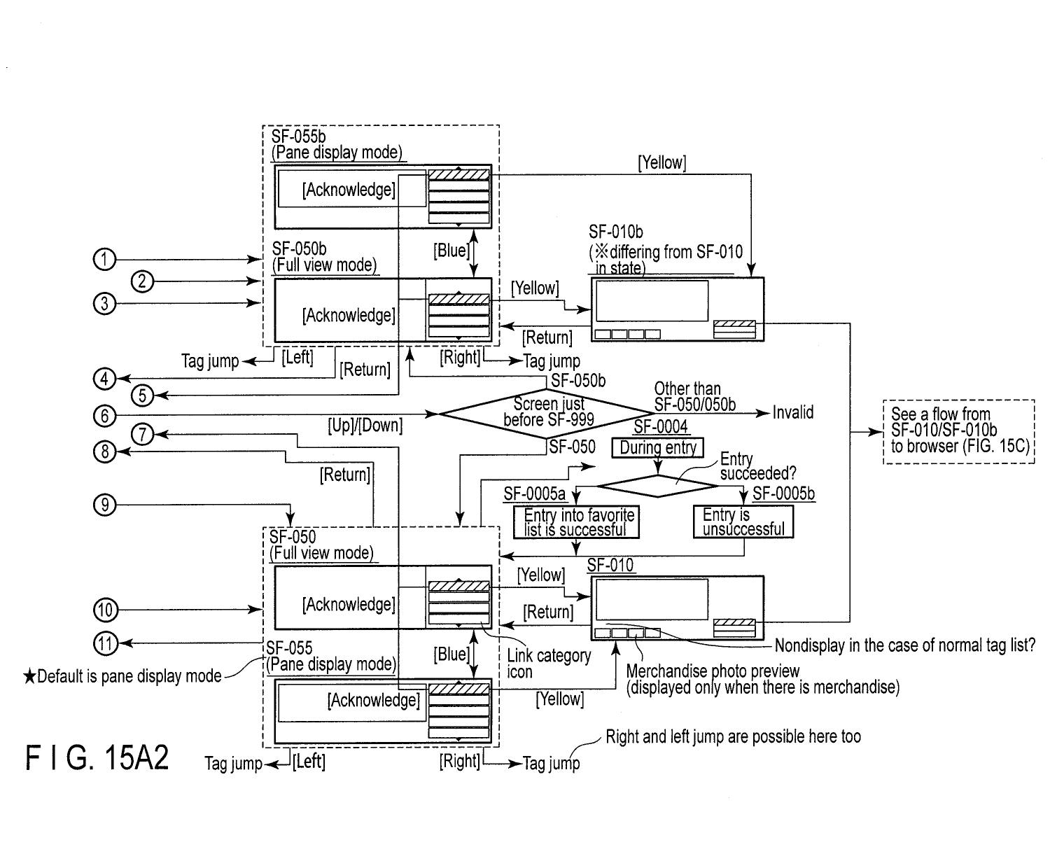

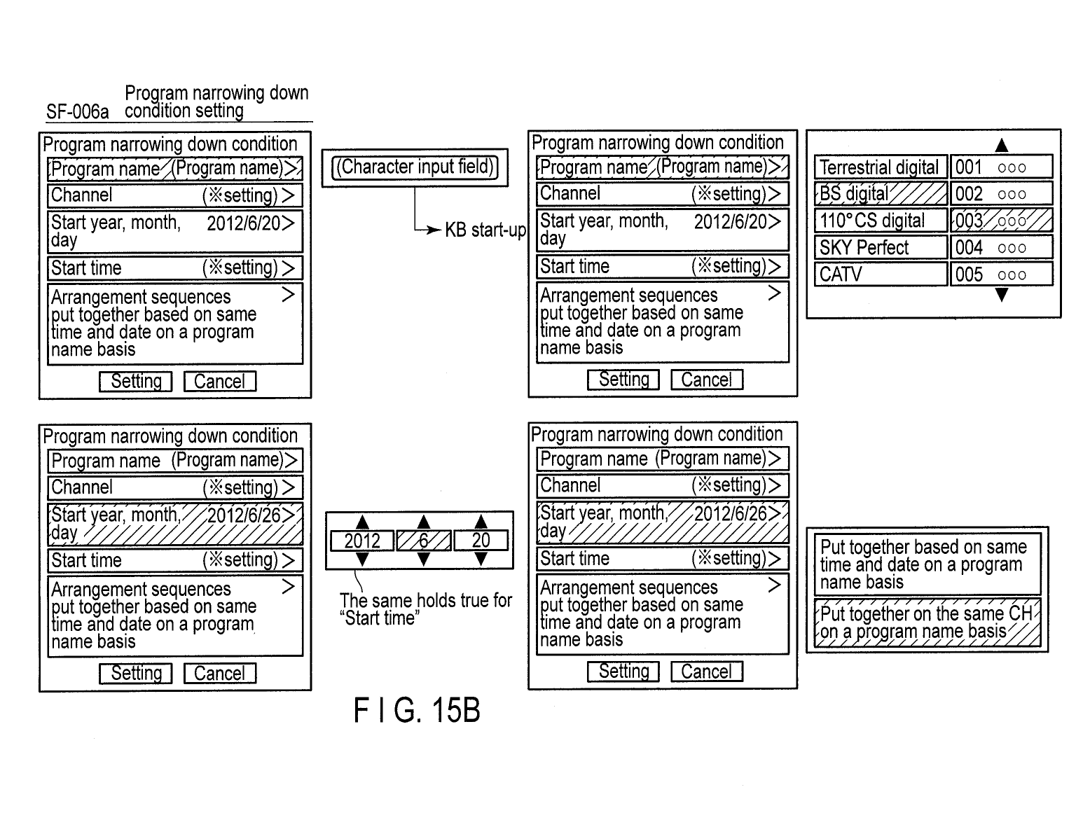

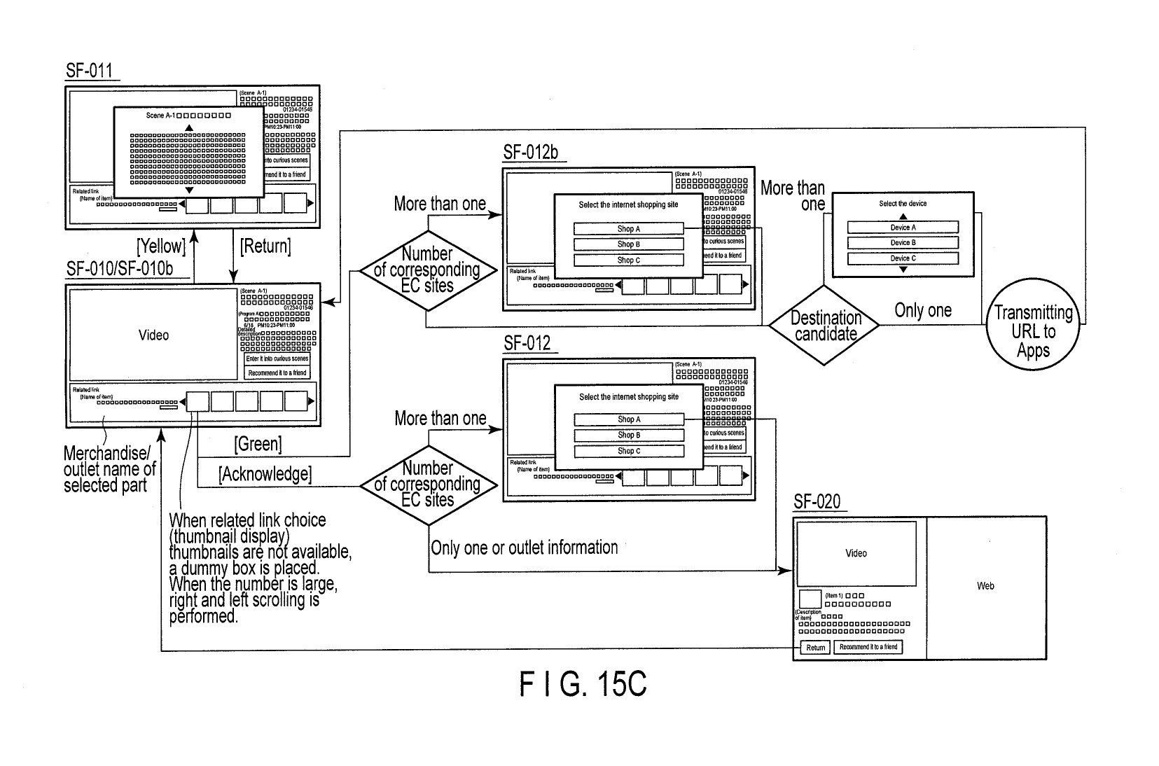

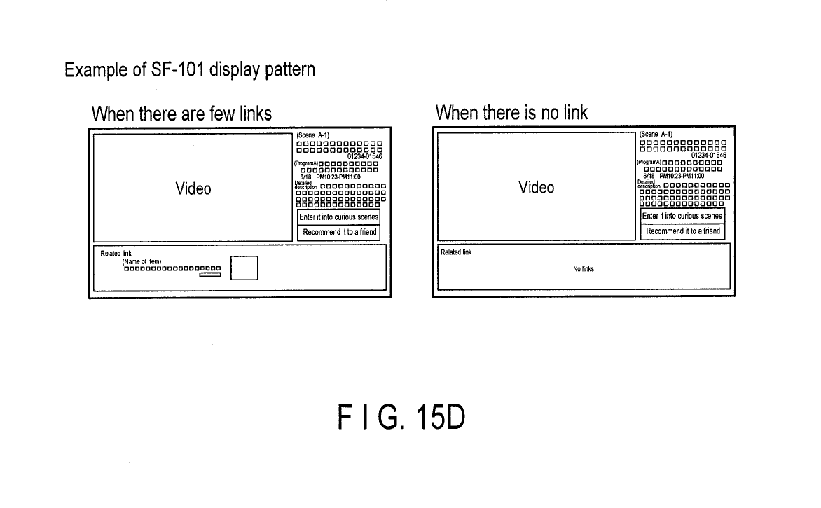

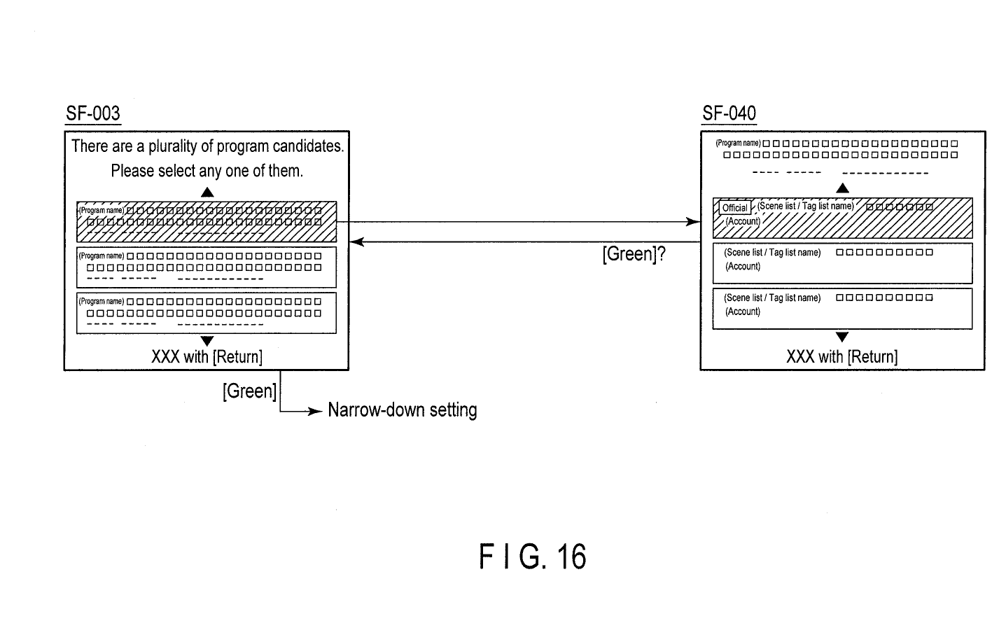

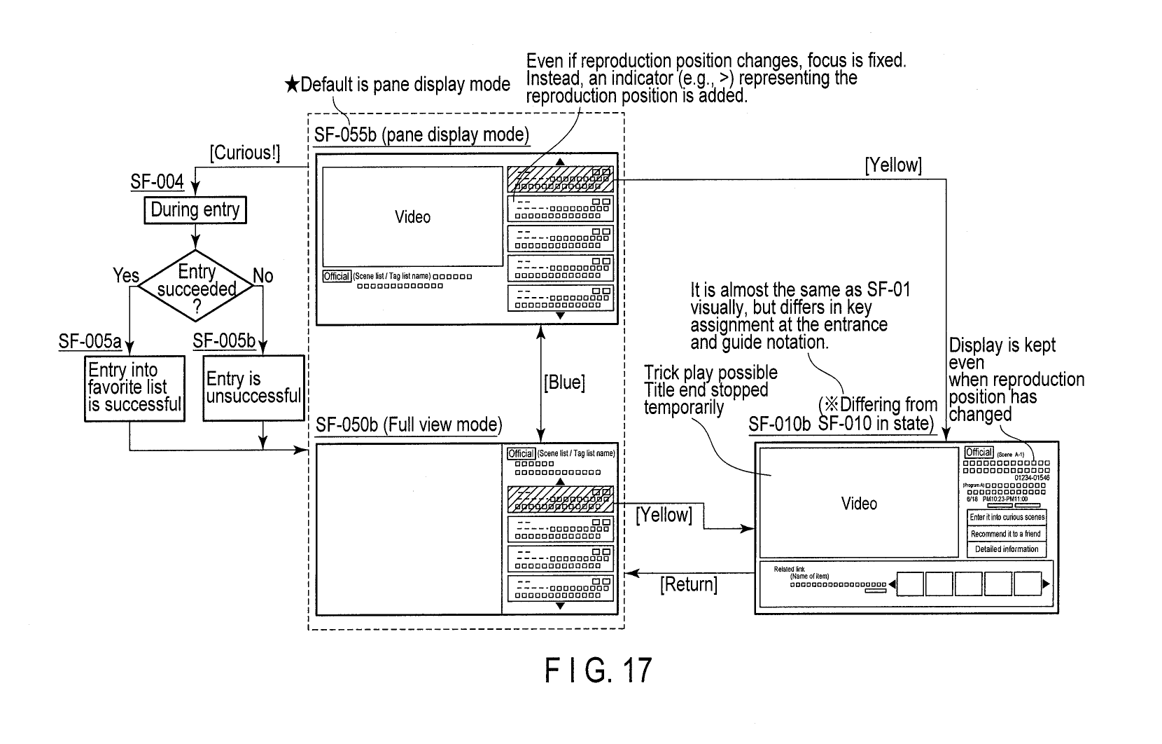

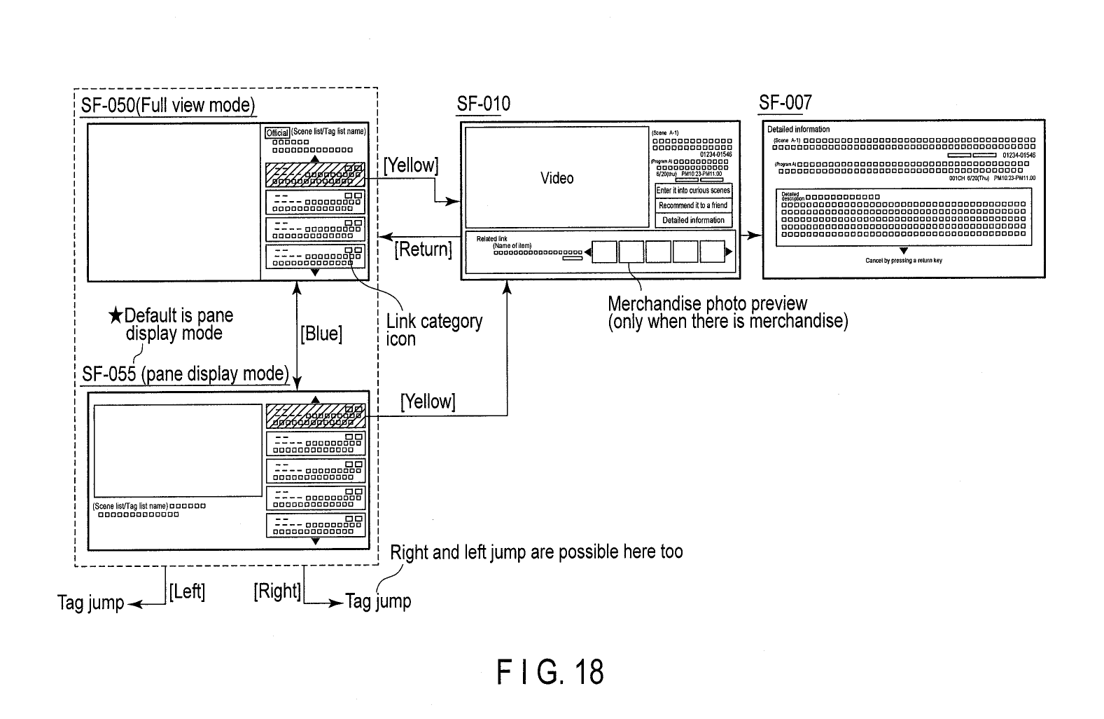

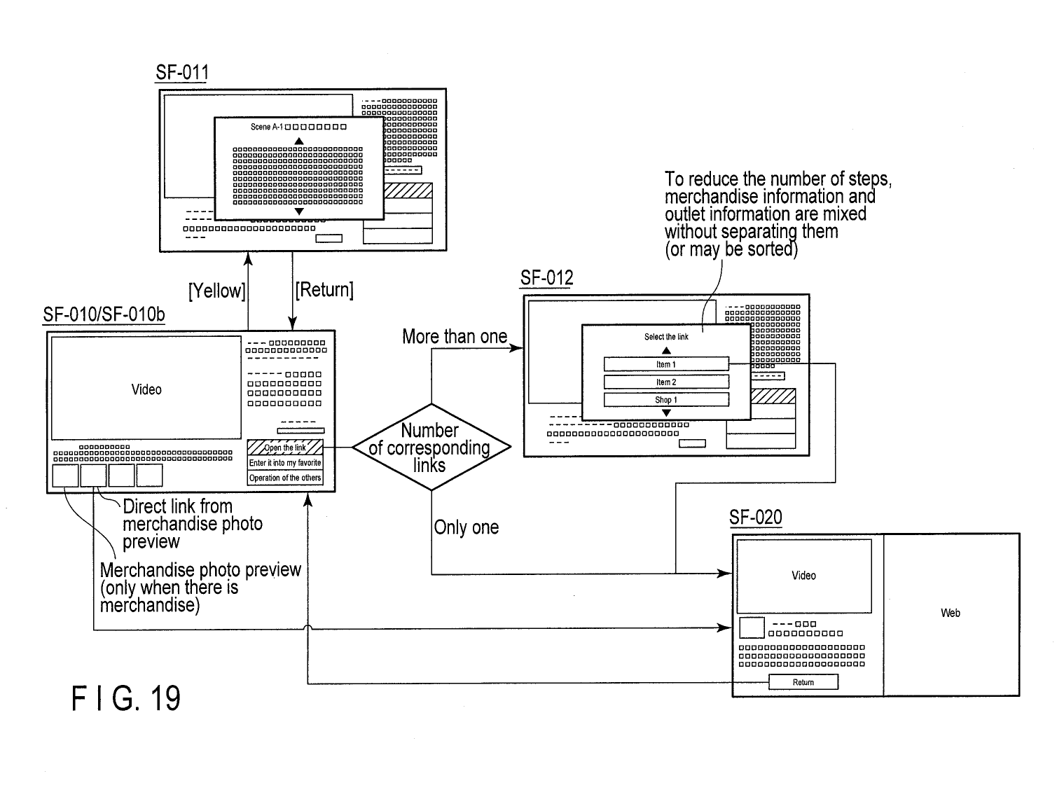

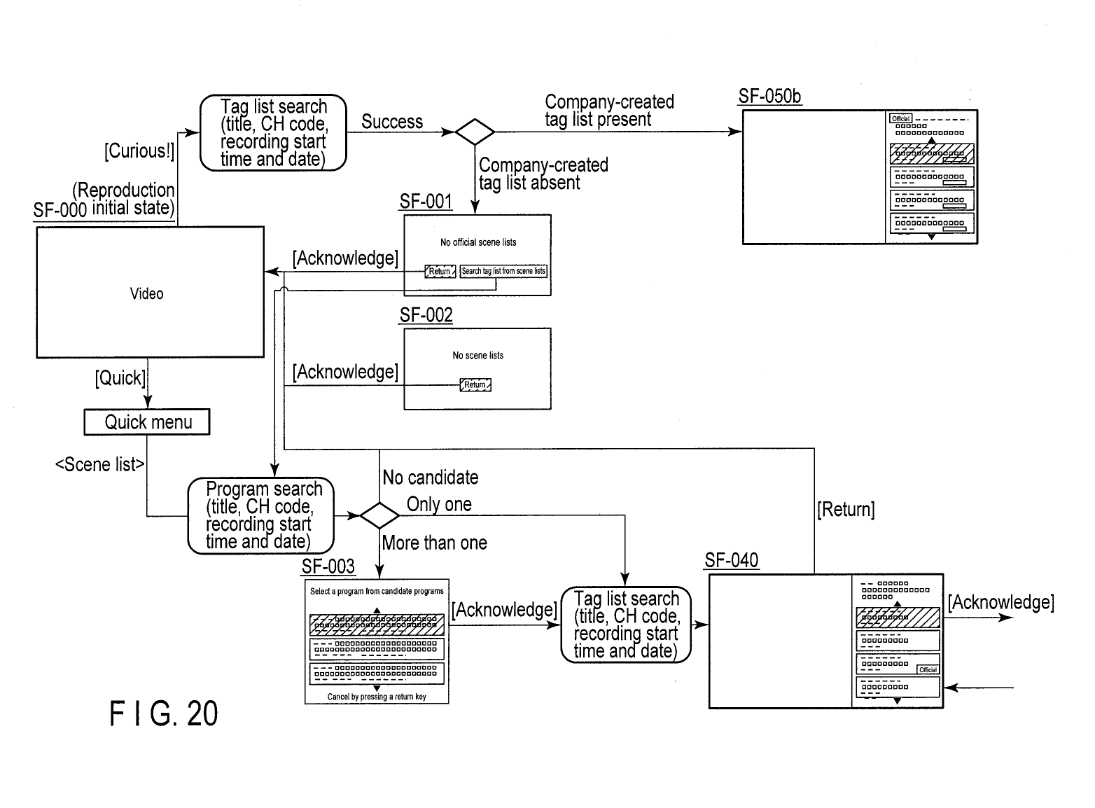

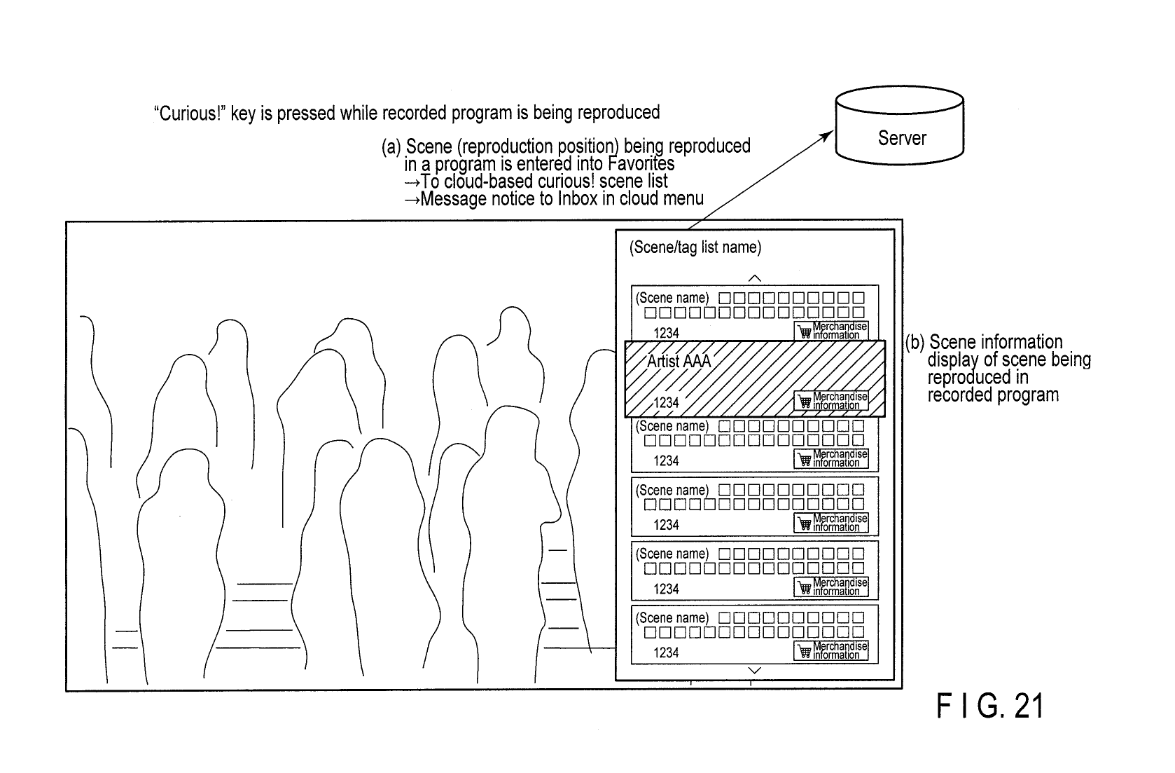

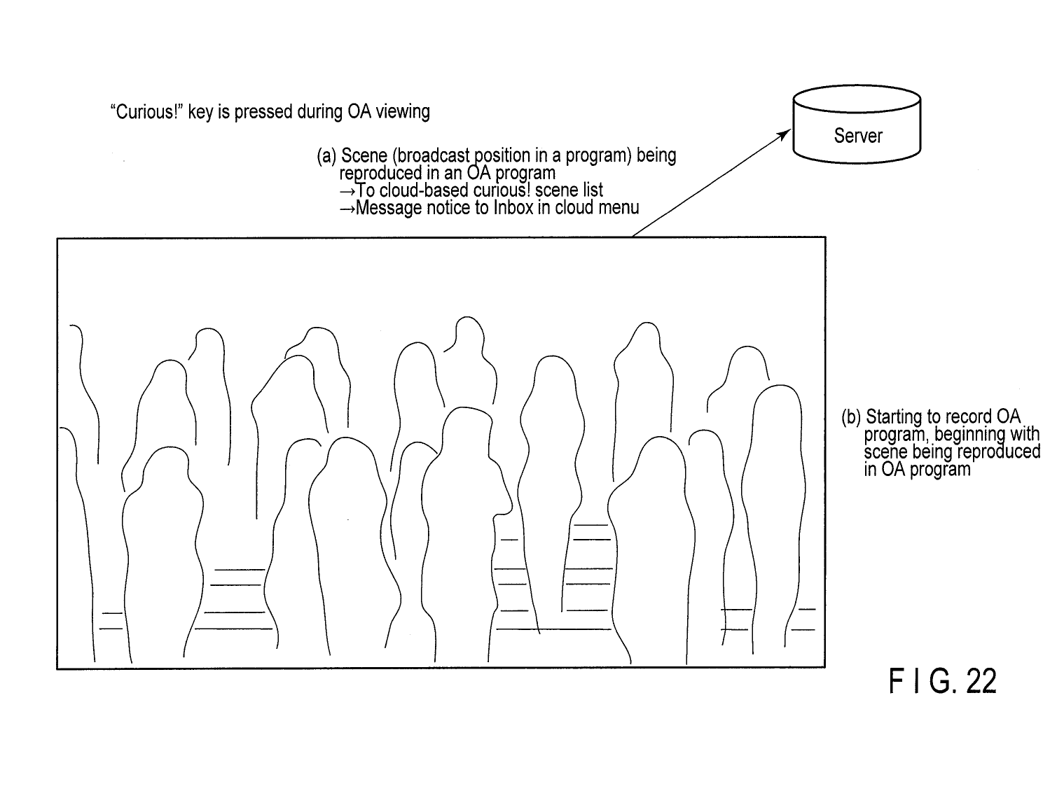

Next, an example of screen transition will be explained. FIGS. 15A, 15A1, 15A2, 15B, 15C, and 15D show an example of screen transition. FIGS. 16 to 20 show an example of the details of screen transition. FIGS. 21 to 24 each show an example of a screen.

For example, in a state where the DTV 1 is displaying, for example, a recorded content item (a recorded program) reproduction screen in a reproduction initial state or a browser initial state (SF-000/SF-999 in FIG. 15A), when the DTV 1 has detected that the “Curious!” key has been pressed, the DTV 1 displays scene information being reproduced, scene information after reproduction, and scene information before reproduction in list form.

FIG. 21 shows a list representation of scene information. When having detected that the “Curious!” key has been pressed while a recorded content item (a recorded program) is being reproduced, the DTV 1 enters, for example, a scene currently being reproduced (reproduction position) into Favorites and further into a cloud-based curious! scene list and informs the Inbox of the cloud menu of a message. In addition, the DTV 1 displays a plurality of items of scene information (scene information currently being reproduced, scene information after reproduction, and scene information before reproduction) in list form. Scene information includes merchandise information icons and the like. The user can view a merchandise information site or a merchandise purchase site according to a scene by just selecting a merchandise information icon.

In a state where the DTV 1 is displaying, for example, a broadcast content item (an OA program) reproduction screen (real-time reproduction screen) in a reproduction initial state or a browser initial state (SF-000/SF-999 in FIG. 15A), when the DTV 1 has detected that the “Curious!” key has been pressed, the DTV 1 enters, for example, a scene (broadcast position) currently being reproduced into a cloud-based curious! scene list and informs the Inbox of the cloud menu of a message. In addition, the DTV 1 starts to record a scene currently being reproduced and subsequent ones.

As described above, the processes based on the depression of the “Curious!” key are switched according to a reproduction situation. That is, when having detected that the “Curious!” key has been pressed while a recorded content item is being reproduced, the DTV 1 displays scene information. When having detected that the “Curious!” key has been pressed while broadcast content is being reproduced, the DTV 1 starts recording.

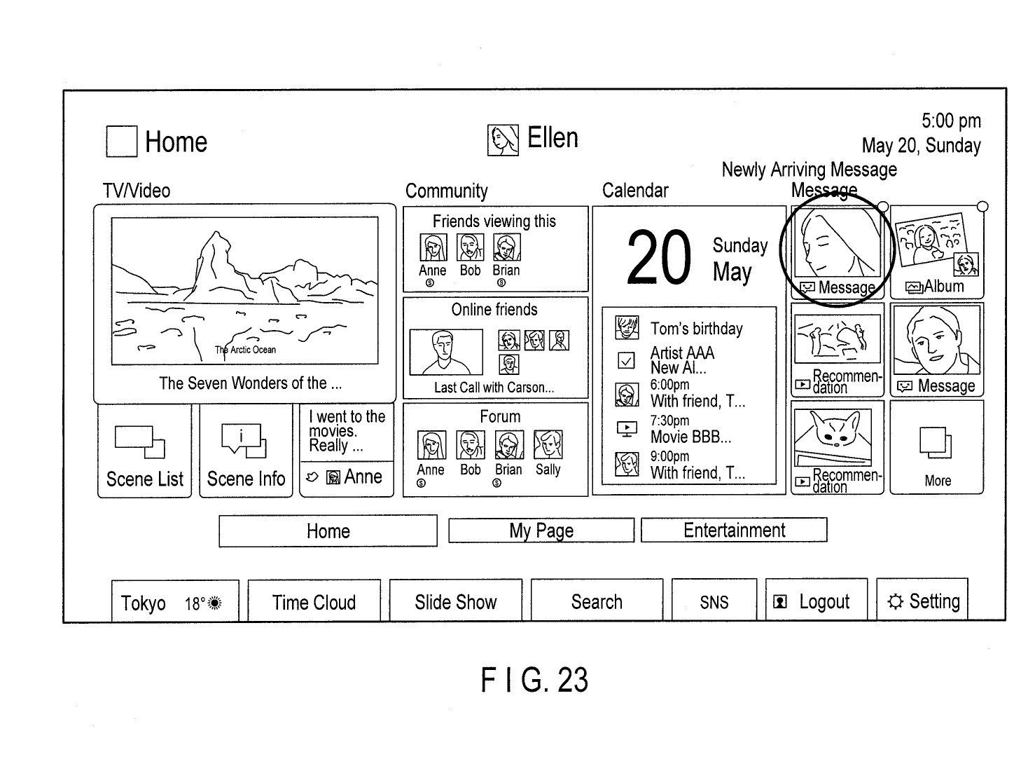

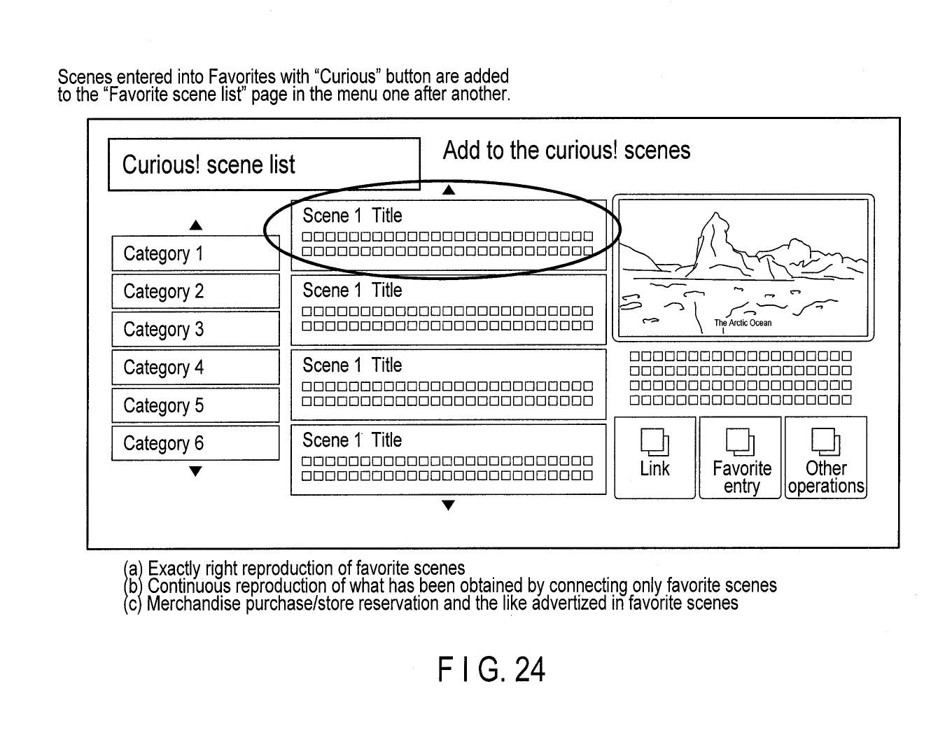

FIG. 23 shows a cloud menu displayed by the DTV 1. The notice of the message is reflected on the message icon. In addition, the scene list icon can be selected to display a scene list screen of FIG. 24. That is, the entered scene information can be selected from the scene list screen. For example, when the user has selected desired entered scene information, the DTV 1 reproduces a scene corresponding to the selected desired entered scene information. In addition, when the user has selected continuous reproduction on the basis of a plurality of items of entered scene information, the DTV 1 links a plurality of scenes corresponding to a plurality of items of entered scene information and reproduces the linked scenes continuously. Moreover, when the user has selected a merchandise icon, a shopping icon, or the like included in entered scene information, the DTV 1 displays a merchandise information site, a merchandise purchase site, a shopping site, or the like.

Hereinafter, an example of the recommended specification of a time cloud is shown.

<Recommended Scenes>

Highly Recommended Scene

A time slot with a high rating is calculated on the basis of a viewing log and scenes of the corresponding data are set as scenes with a high rating. Of the scenes, one in a program recorded by the user is recommended.

Popular Scene

Tag scenes with many tag jumps are calculated on the basis of a tag jump log in a time cloud. Of the tag scenes, one in a program recorded by the user is recommended.

Everyone's Curious Scene

Scene tags frequently bookmarked are calculated on the basis of scene tags entered into Favorites by time cloud users. Of the scene tags, one in a program recorded by the user is recommended.

Twitter Lively Scene

A time slot with a large number of tweets is calculated on the basis of tweets to a broadcast station hashtag. A scene managed by a corresponding metadata creation server is recommended as a lively scene.

Friend's Recommended Scene

A scene transmitted by a friend using “Message transmission to a friend” is recommended.

User's Recommended Scene List

A scene list created by the user collecting the user's favorite tag scenes is presented.

Friend Viewing Scene

A tag scene with many tag jumps is calculated on the basis of a friend's log of tag jumps. The tag scene is recommended.

Popular Merchandise and Outlet Scene

The number of jumps to purchase sites is tallied. Purchase sites with a large number of jumps are recommended. The number of jumps to outlet sites (outlets) is tallied. Outlet sites with a large number of jumps are recommended.

Recommended Scenes for You

Personalized recommendation. Scenes suiting the user's tastes are calculated on the basis of other user's profile-viewing scene logs. Of the scenes, one in a program recorded by the user is recommended.

All of the procedures for the above processes can be realized with software (a scene information output program). Therefore, the processes can be realized by just installing a program (an application) for executing the processing procedure into a client terminal or a mobile terminal and running the program.

For example, the client terminal or mobile terminal can download the program from a server, store the downloaded program, and complete the installation of the program. Alternatively, the client terminal or mobile terminal can read the program from a computer-readable storage medium, store the read program, and complete the installation of the program.

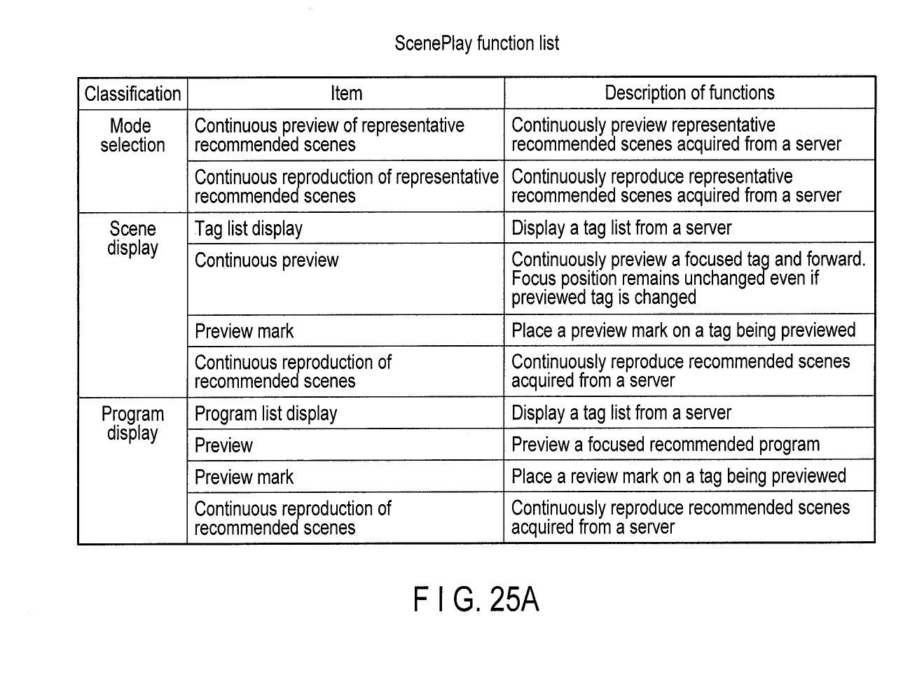

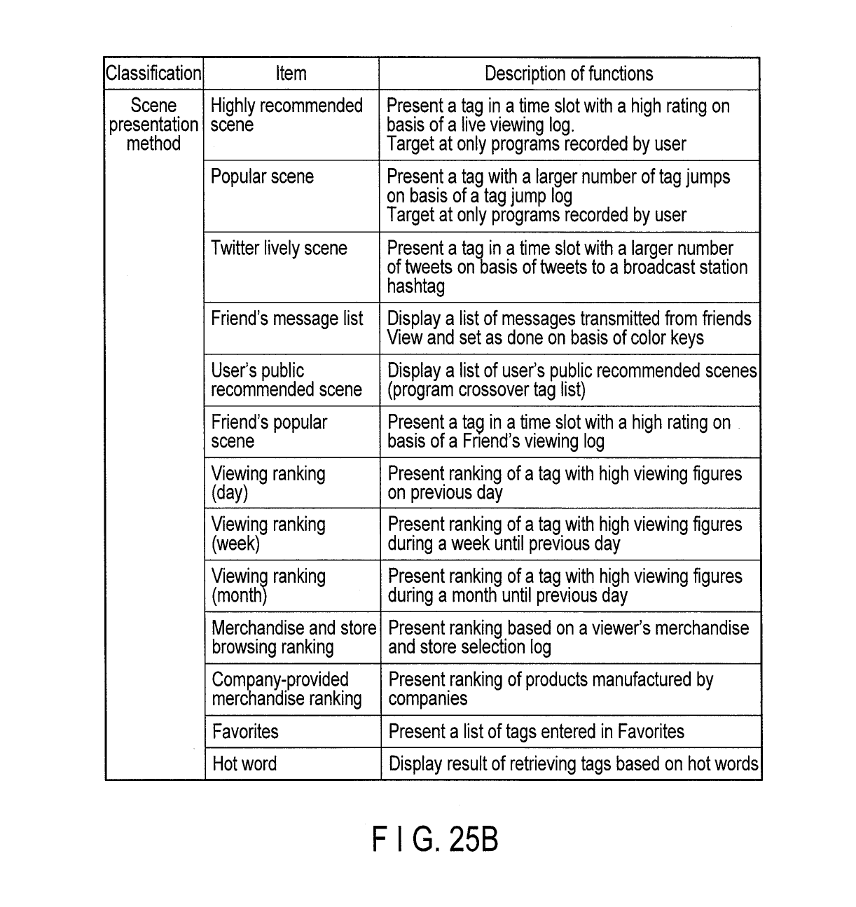

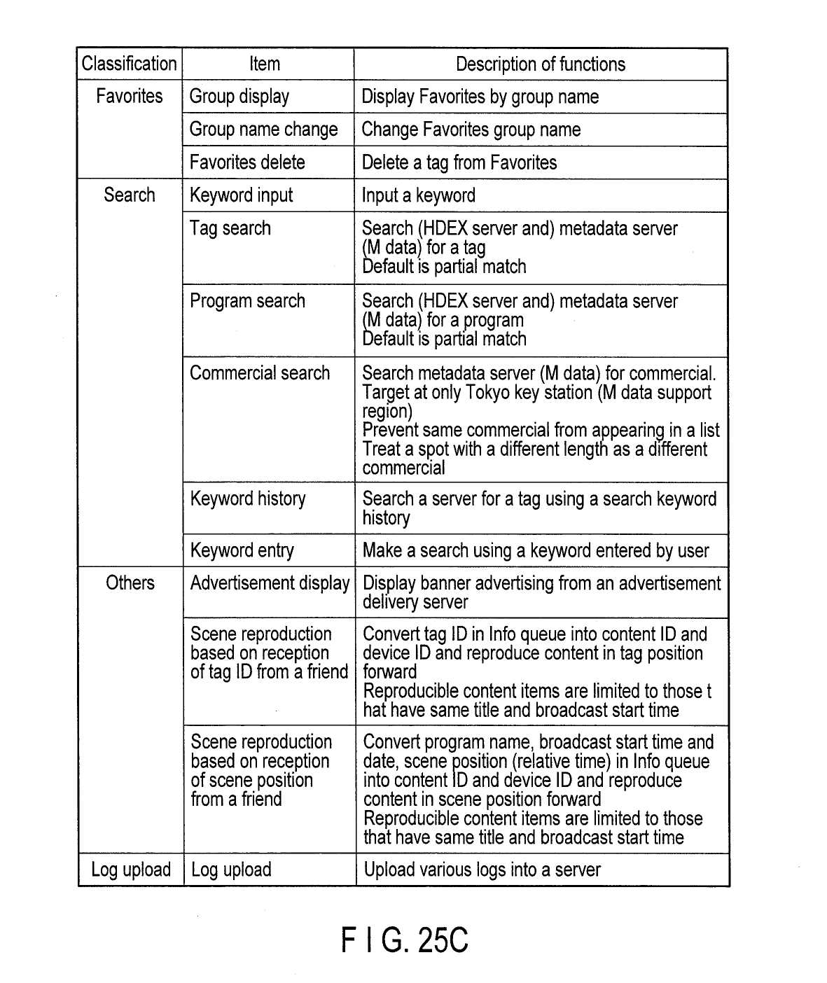

Hereinafter, the reproduction of a scene unit by ScenePlay in the DTV will be explained. FIGS. 25A, 25B, and 25C show an example of a list of ScenePlay functions.

For example, the DTV transmits a recording log of recorded content items to a server in response to a content recording process. The recording log includes DTV identification data and recorded content identification data (program name, program airdate, channel number, ID, and the like). The server manages recorded content identification data items so as to cause the identification data items to correspond to DTV identification data items. This enables the server to manage all of the content items recorded by the DTV.

That is, the DTV can manage all of the reproducible content items. For example, a history collection server S13 in FIG. 10 manages all of the content items each DTV can reproduce. While all of the content items recorded by the DTV have been explained as being reproducible, all of the content items recorded by a recorder connected to the DTV can also be included as reproducible content items. A device in which content is to be recorded may be a storage medium (for example, a hard disk) built in the DTV, a storage medium externally connected to the DTV, a storage medium built in a recorder, or a storage medium externally connected to a recorder.

The server manages a plurality of items of scene information corresponding to a plurality of scenes included in each of a plurality of content items. The server transmits, to the DTV, items of scene information corresponding to content items that can be reproduced by the DTV. For example, the metadata server S11 shown in FIG. 10 manages a plurality of items of scene information. The scene information includes identification data (program name, program airdate, channel number, ID, and the like). Since the server manages identification data items on recorded content items that can be reproduced by the DTV, it can detect an item of scene information to be transmitted to the DTV and transmit the detected item of scene information to the DTV. Specifically, the server compares an identification data item on a recorded content item that can be reproduced by the DTV with a identification data item on an item of scene information and transmits the item of scene information to the DTV when, for example, at least a part of the identification data item on the recorded content item coincides with at least a part of the identification data item on the item of scene information.

The DTV receives, from the server, one or more items of scene information corresponding to one or more scenes of one or more content items. Here, it is assumed that the DTV receives, from the server, a plurality of items of scene information corresponding to a plurality of scenes of each of a plurality of content items.

In addition, the DTV can retrieve recommended ones from a plurality of items of scene information on the basis of at least either various items of information (including audience rating information explained below) or specified conditions from the server and present (display) the retrieved items of scene information. For example, the DTV can present items of recommended scene information by category (see FIG. 25B).

For example, on the basis of surging search word information (popular search keyword information) from the server, the DTV can present a plurality of items of scene information as highly recommended scenes. For example, the DTV can present a plurality of items of scene information corresponding to the top 10 surging search words included in the surging search word information. That is, the DTV can present a plurality of items of scene information including the top 10 surging search words. The DTV can not only reproduce a scene corresponding to the selected one of the items of scene information corresponding to the top 10 surging search words (for example, a scene corresponding to the first place in the surging search words) but also consecutively reproduce a plurality of scenes corresponding to the items of scene information corresponding to the top 10 surging search words (for example, a plurality of scenes that take the first to tenth places in the surging search words).

For example, on the basis of audience rating information from the server, the DTV can present a plurality of items of scene information as highly recommended scenes. For example, the DTV can present the items of scene information corresponding to the audience rating top 10 included in the audience rating information. The audience rating information, which is created on the basis of the result of tallying up reproduction logs or the like from a plurality of DTVs, includes IDs of the items of scene information about the first to tenth places in the audience ratings. The DTV can not only reproduce a scene corresponding to the selected one of the items of scene information corresponding to the audience rating top 10 (for example, a scene corresponding to the first place in the audience ratings) but also consecutively reproduce a plurality of scenes corresponding to the items of scene information corresponding to the audience rating top 10 (for example, a plurality of scenes that take the first to tenth places in the audience ratings). For example, as shown in FIG. 36, the DTV can present a plurality of items of scene information corresponding to the top 30 popular scenes.

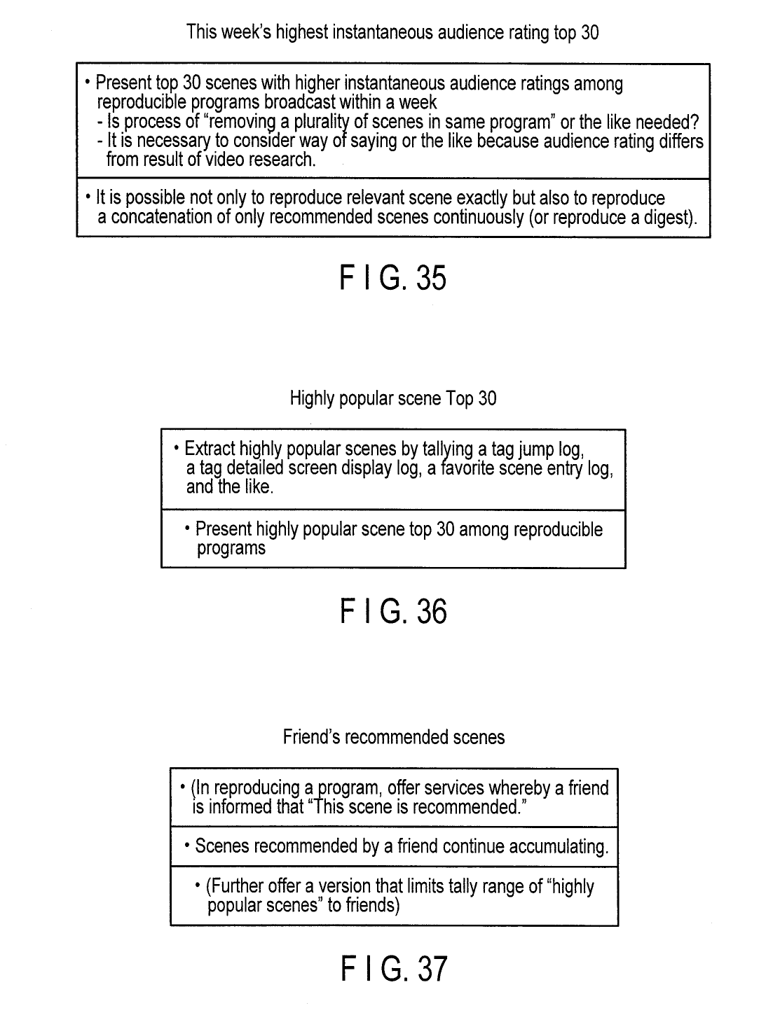

When an item of scene information has been selected, the DTV retrieves a scene in a content item on the basis of identification data included in the selected item of scene information and reproduces the retrieved scene. For example, the DTV can retrieve a scene from the content items broadcast and recorded within a week. When a plurality of items of scene information have been selected, the DTV retrieves a plurality of scenes from a plurality of content items on the basis of a plurality of identification data items included in the selected items of scene information and reproduces the retrieved scenes. For example, the DTV can retrieve a plurality of scenes from the content items broadcast and recorded within a week. In addition, as shown in FIG. 35, the DTV can present a plurality of items of scene information corresponding to the instantaneous audience rating top 30.

Furthermore, on the basis of popular scene information (scene information with a high reproduction rate), the DTV can present a plurality of items of scene information as popular scenes. For example, the DTV can present a plurality of items of scene information corresponding to the popular scene top 10 included in the popular scene information. The popular scene information, which is created on the basis of the result of tallying reproduction logs or the like from a plurality of DTVs, includes IDs of the items of popular scene information about the first to tenth places in the popular scenes. The DTV can not only reproduce a scene corresponding to the selected one of the items of scene information corresponding to the popular scene top 10 (for example, a scene corresponding to the first place in the popular scenes) but also consecutively reproduce a plurality of scenes corresponding to the items of scene information corresponding to the popular scene top 10 (for example, a plurality of scenes that take the first to tenth places in the popular scenes). For example, as shown in FIG. 36, the DTV can present a plurality of items of scene information corresponding to the top 30 popular scenes.

When an item of scene information has been selected, the DTV retrieves a scene in a content item corresponding to the identification data included in the selected scene information and reproduces the retrieved scene. When a plurality of items of scene information have been selected, the DTV retrieves a plurality of scenes from a plurality of content items corresponding to a plurality of identification data items included in the selected items of scene information and reproduces the retrieved scenes.

In addition, on the basis of popular site information from the server, the DTV can present a plurality of items of scene information as scenes related to popular site information. The DTV can present a plurality of items of scene information related to the popular site top 10 included in the popular site information. For example, the popular site information, which is created on the basis of the result of tallying site access histories or the like, includes IDs of the items of popular site information about the first to tenth places in the popular sites. The DTV can not only reproduce a scene corresponding to the selected one of the items of scene information corresponding to the popular site top 10 (for example, a scene corresponding to the first place in the popular sites) but also consecutively reproduce a plurality of scenes corresponding to the items of scene information related to the popular site top 10 (for example, a plurality of scenes that take the first to tenth places in the popular sites).

Moreover, as shown in FIG. 37, the DTV can not only present Friend's recommended scene information but also reproduce a scene corresponding to one selected from the presented items of scene information.

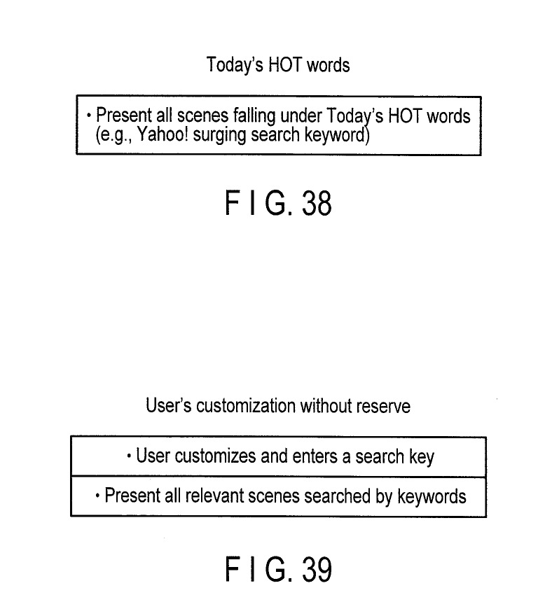

Furthermore, as shown in FIG. 38, the DTV can not only present items of scene information corresponding to Today's hot words but also reproduce a scene corresponding to one selected from the presented items of scene information.

For example, the DTV can collect only goal scenes in soccer games and reproduce them consecutively.

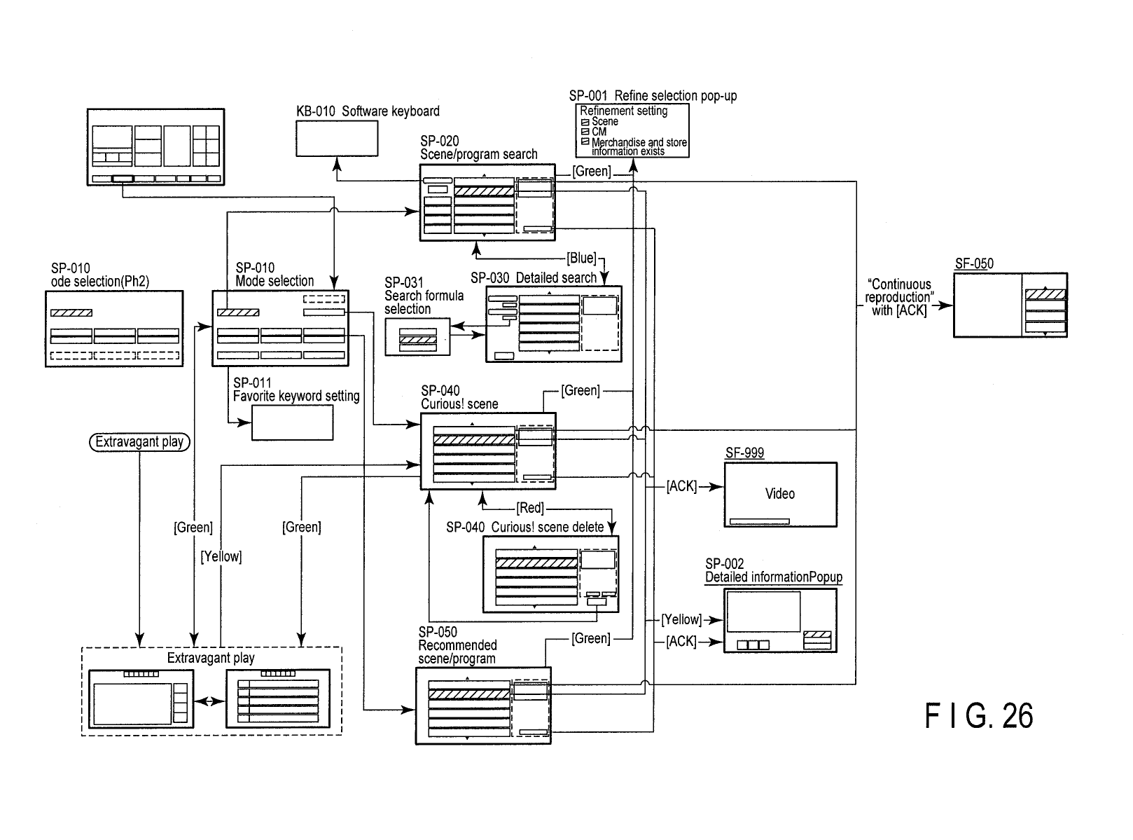

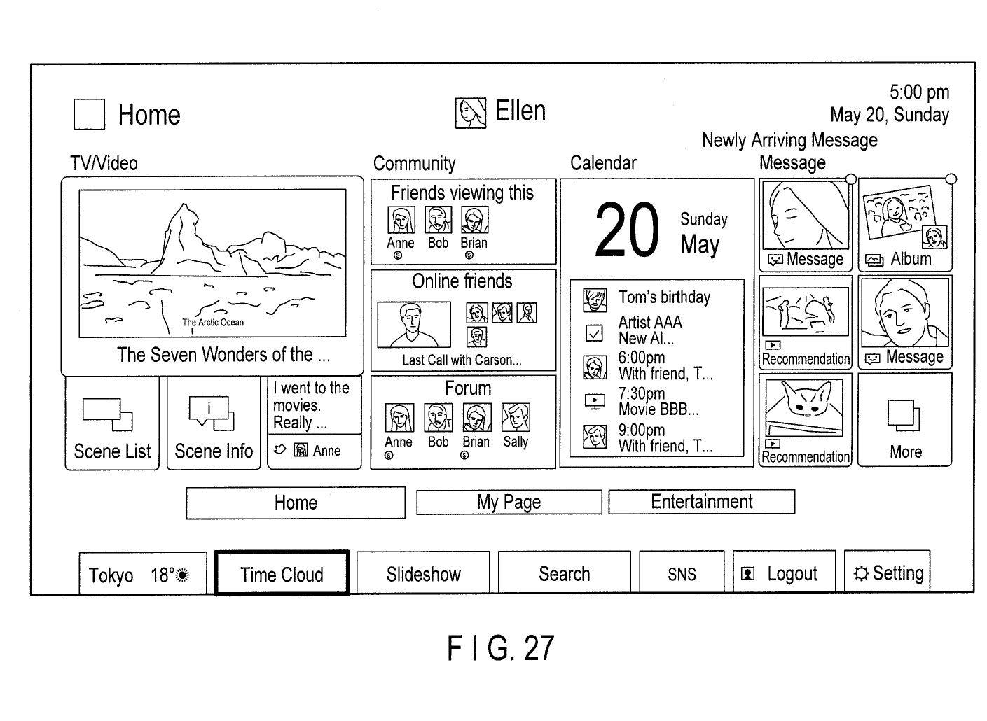

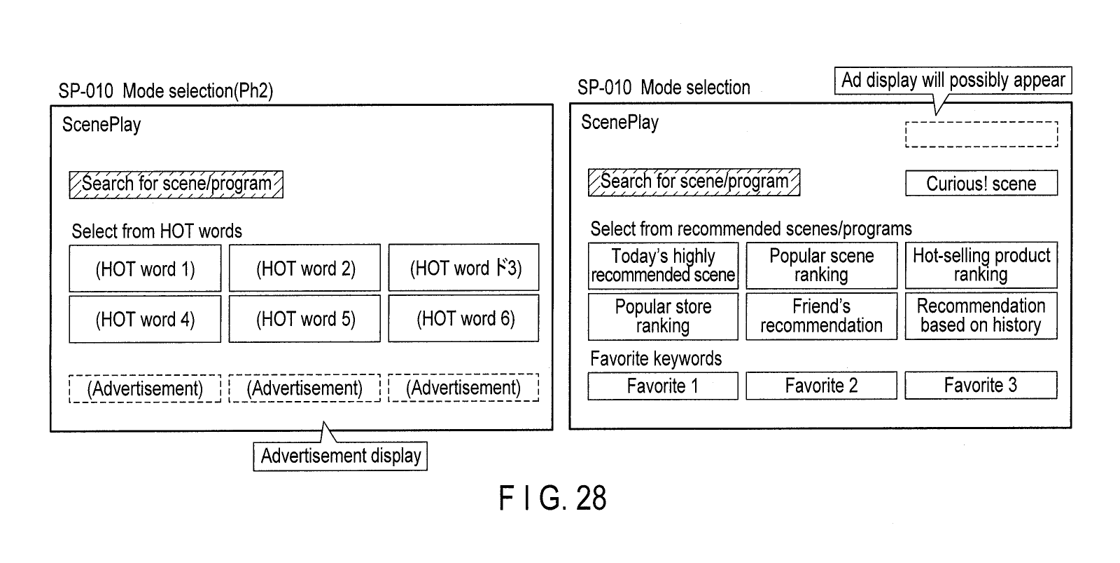

Next, an example of the transition of screens will be explained. FIG. 26 shows an example of the transition of ScenePlay screens. FIG. 27 shows an example of a cloud menu screen. FIGS. 28 to 33 each show an example of a screen after the transition.

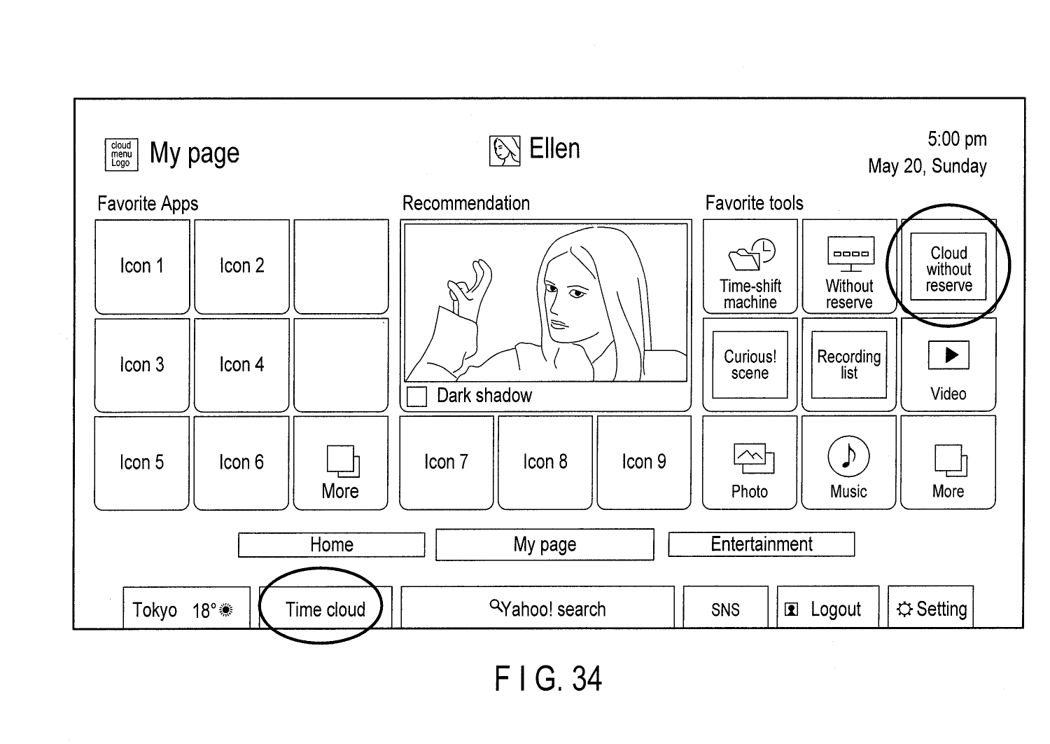

For example, when the DTV has displayed a cloud menu screen (see FIG. 27 or 34) and a time cloud has been selected from the cloud menu screen, the DTV displays a by-category scene reproduction screen (see FIG. 28). For example, the by-category scene reproduction screen includes the following items: Today's highly recommended scene, Popular scene ranking, Hot-selling product ranking, Popular store ranking, Friend's recommendation, and Recommendation based on history. Moreover, the by-category scene reproduction screen (see FIG. 28) can be customized by the user. For example, scenes hit by keyword search can be collected and displayed on the user-customized scene reproduction screen (see FIG. 39).

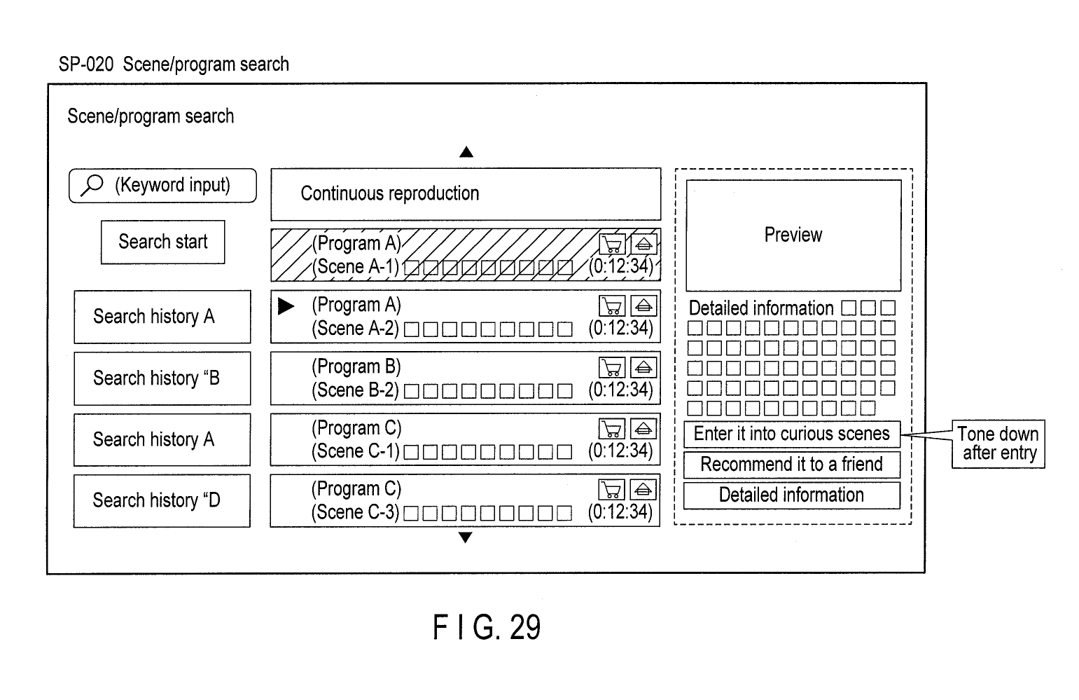

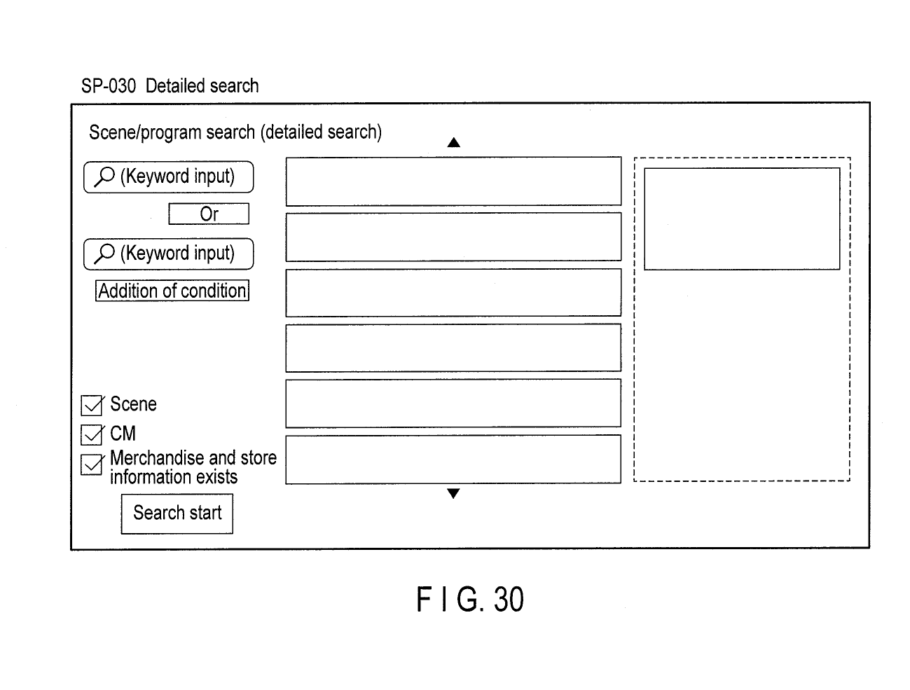

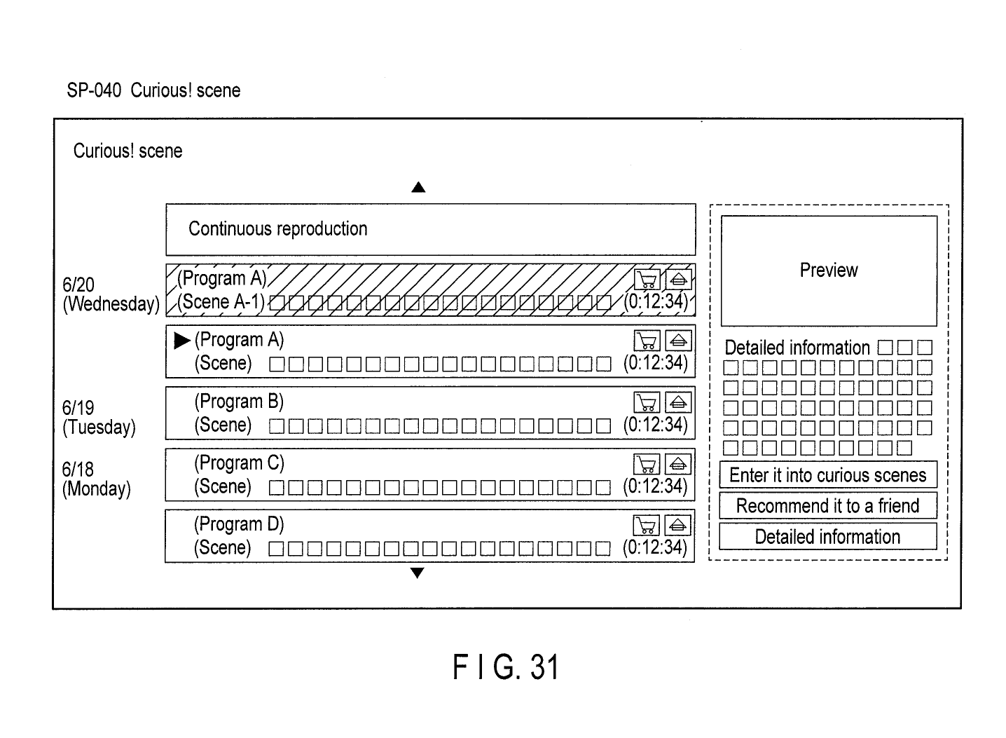

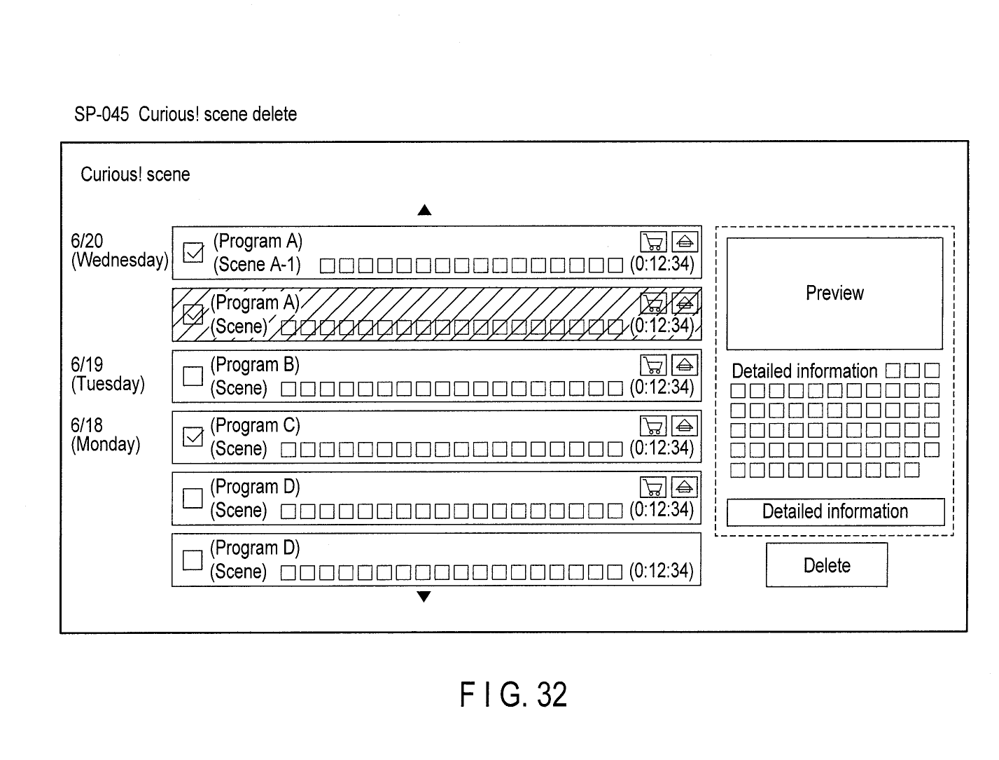

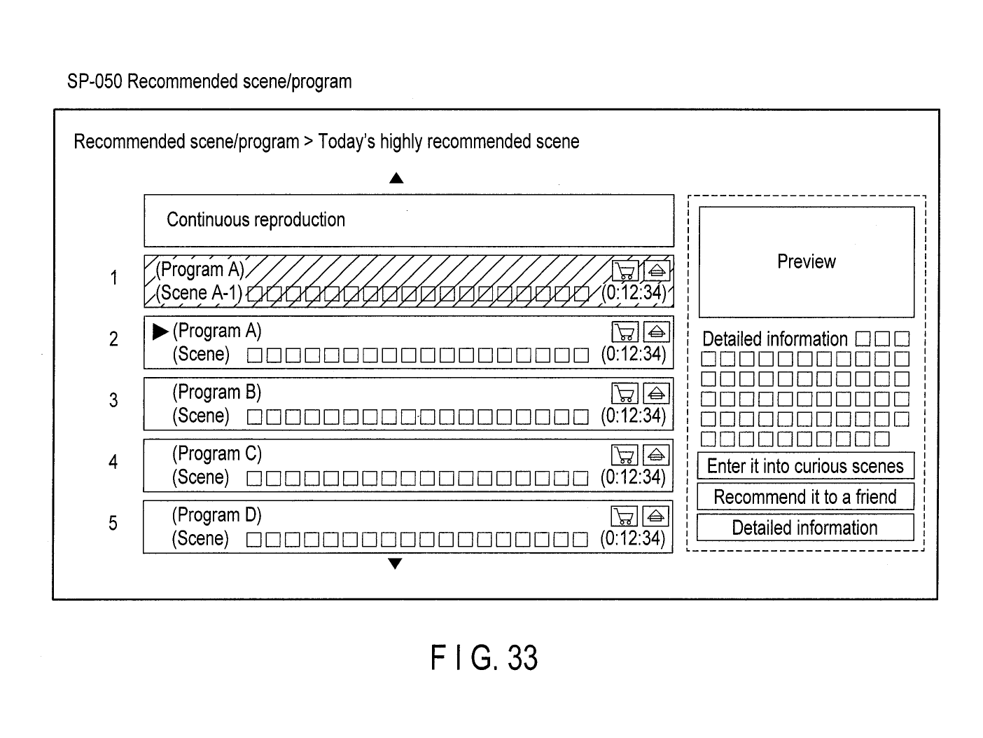

Furthermore, with the transition of screens, the DTV displays a scene/program search screen (see FIG. 29), a detailed search screen (see FIG. 30), a curious scene screen (see FIG. 31), a curious scene delete screen (see FIG. 32), a recommended scene/program screen (see FIG. 33), or the like.

ScenePlay of the DTV described above will be summarized.

The DTV can present a list of recommended scenes, specify a program including a directly selected scene or the selected scene on the basis of the scene selected from the presented list of recommended scenes, and reproduce the specified program or scene. In addition, the DTV can reproduce the concatenation of only recommended scenes continuously.

The details are as follows:

The DTV retrieves recommendations in scenes.

The DTV displays recommended scenes, recommended programs, favorites, and scene retrieval in list form.

The DTV presents a plurality of representative scenes.

The DTV searches programs (recorded content items) the user can view for scenes.

A server stores a recording/deleting log from each DTV to cause the DTV to realize what has been described above. Alternatively, the DTV may retrieve scene information from a server on the basis of a list of recorded content items.

Content items recorded in a recorder or the like connected to the DTV may be made viewable content items on the DTV.

The DTV leaves favorite scenes even if it cannot reproduce them (so as to introduce merchandise or the like).

The DTV leaves a history of a search formula for a Scene search history. Alternatively, the DTV enters a favorite search key.

The DTV can select search in programs or in scenes.

The DTV presents a plurality of recommended scene categories as follows: for example,

Today's highly recommended one

Popular scene

Hot-selling one

Friend's recommendation or the like

When reproducing a plurality of scenes consecutively, the DTV reproduces a scene following the present one or a scene in a content item following the content item including the present scene.

All of the procedures for the above processes can be realized with software (a scene reproduction program). Therefore, the processes can be realized by just installing a program (an application) for executing the processing procedure into a client terminal or a mobile terminal and running the program.

For example, the client terminal or mobile terminal can download the program from a server, store the downloaded program, and complete the installation of the program. Alternatively, the client terminal or mobile terminal can read the program from a computer-readable storage medium, store the read program, and complete the installation of the program.

According to at least one of the above embodiments, it is possible to provide a scene reproduction apparatus, a scene reproduction program, and a scene reproduction method which are capable of reproducing content efficiently.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reproduction apparatus comprising:
a reception module configured to receive an instruction for selection from user in a reproducing of a specific scene of predetermined content;
a communicator configured to receive, from a server, one or more items regarding scene information corresponding to one or more scenes in one or more content items with respect to the specific scene corresponding to the instruction for selection;
a selector configured to select a first item regarding scene information from the one or more items regarding scene information in response to a selection operation;
a detector configured to detect a first scene in a first content item corresponding to the first item regarding scene information; and
a reproducer configured to reproduce the first scene.

2. The apparatus of claim 1, wherein the communicator is configured to transmit identification data items on a plurality of reproducible content items to the server and to receive, from the server, a plurality of items regarding scene information corresponding to a plurality regarding scenes included in each of the content items.

3. The apparatus of claim 2, wherein the communicator is configured to transmit, to the server, a content recording log that comprises the identification data items on a plurality of recorded content items.

4. The apparatus of claim 2, further comprising:
a search module configured to search the items regarding scene information for one or more items of condition-satisfying scene information that satisfy a specified condition; and
a presentation module configured to present one or more items of condition-satisfying scene information searched for,
wherein the selector is configured to select the first item regarding scene information from the presented one or more items of condition-satisfying scene information in response to the selection operation.

5. The apparatus of claim 4, wherein the communicator is configured to receive popular search keyword information, and
the search module is configured to search the items regarding scene information for the one or more items of condition-satisfying scene information based on the popular search keyword information.

6. The apparatus of claim 4, wherein the communicator is configured to receive audience rating information, and
the search module is configured to search the items regarding scene information for the one or more items of condition-satisfying scene information based on the audience rating information.

7. The apparatus of claim 4, wherein the communicator is configured to receive popular scene information, and
the search module is configured to search the items regarding scene information for the one or more items of condition-satisfying scene information based on the popular scene information.

8. The apparatus of claim 4, wherein the communicator is configured to receive popular site information, and
the search module is configured to search the items regarding scene information for the one or more items of condition-satisfying scene information based on the popular site information.

9. The apparatus of claim 4, wherein the communicator is configured to receive Friend's recommended information, and
the search module is configured to search the items regarding scene information for the one or more items of condition-satisfying scene information based on the Friend's recommended information.

10. The apparatus of claim 4, wherein the presentation module is configured to present items of condition-satisfying scene information by category.

11. The apparatus of claim 4, wherein the reproducer is configured to consecutively reproduce a plurality of scenes corresponding to the items of condition-satisfying scene information searched for in response to a scene consecutive reproduction instruction.

12. A non-transitory computer-readable medium comprising a computer program configured to be executed by a computer, the computer program causing the computer to execute:
a first procedure for receiving, from a server, one or more items regarding scene information corresponding to one or more scenes in one or more content items;
a second procedure for selecting a first item regarding scene information from the one or more items regarding scene information in response to a selection operation;
a third procedure for detecting a first scene in a first content item corresponding to the first item regarding scene information; and
a fourth procedure for reproducing the first scene.

13. A scene reproduction method comprising:
receiving, from a server, one or more items regarding scene information corresponding to one or more scenes in one or more content items;
selecting a first item regarding scene information from the one or more items regarding scene information in response to a selection operation;
detecting a first scene in a first content item corresponding to the first item regarding scene information; and
reproducing the first scene.
